(19) United States
(12) Patent Application Publication
(10) Pub. No.: US 2026/0004568 A1
(43) Pub. Date: Jan. 1, 2026

(54) ADVANCING ENSEMBLE LEARNING AGAINST UNLEARNABLE DATA

(71) Applicant: UNIVERSITY OF SOUTH FLORIDA, Tampa, FL (US)

(72) Inventors: Kaiqi XIONG, Tampa, FL (US); Hapuarachchige Thushari Saumya HAPUARACHCHI, Tampa, FL (US)

(21) Appl. No.: 19/255,748

(22) Filed: Jun. 30, 2025

Related U.S. Application Data
(60) Provisional application No. 63/666,440, filed on Jul. 1, 2024.

(51) Int. Cl. G06V 10/774; G06V 10/766; G06V 10/776; G06V 10/82

(52) U.S. Cl. CPC G06V 10/7747; G06V 10/766; G06V 10/776; G06V 10/82

(57) ABSTRACT

Systems and methods are provided herein for advancing ensemble learning methods, including stacking, boosting, and bagging, for defeating data protection approaches by converting their generated unlearnable data into learnable ones. Processes of the present disclosure may enhance and implement ensemble learning on the unlearnable data while incorporating nonlinear transformations.

### CROSS-REFERENCE TO RELATED APPLICATION(S)

This application claims priority to U.S. Provisional Patent Application No. 63/666,440, filed on Jul. 1, 2024, the entire contents of which are incorporated herein by reference for all purposes.

### BACKGROUND

The unauthorized acquisition of image data for training deep neural network (DNN) models raises significant privacy concerns. The Internet, including social media platforms like Facebook and Instagram, is brimming with freely-available personal data. The illegitimate scraping of these data for training machine learning models, e.g., deep neural network (DNN) models, has become a severe issue. A potential solution to address this concern is to render data “unlearnable” to disrupt the training process of DNN models. Data protection approaches, also known as “unlearnable data,” which obfuscate data from machine learning training, have been used to prevent such unauthorized utilization of image data for DNN model training. Unlearnable data is intended to be able to protect data from use in any advanced machine learning methods.

Given the unpredictable nature of the machine-learning techniques that unauthorized users may employ, unlearnable data should possess the capability to guard against various advanced machine learning approaches. However, there have been attempts to overcome such data protection approaches so that machine learning models can still train on the “unlearnable” data.

FIG. 1 shows related art examples of unlearnable data techniques and corresponding single-learner model prediction results.

In FIG. 1, the first row 110 shows an original image and twelve (12) examples of unlearnable data protection approaches. The second row 120 shows unlearnable example images respectively generated using each of the unlearnable data protection approaches. The third row 130 shows corresponding perturbations (or prediction images) generated by a single-learner (single-model) approach for a machine-learning model trained on each respective protection approach.

The fourth row 140 lists the respective test accuracies (as a percentage %), representing the accuracy of each prediction image output by a model trained on an unlearnable dataset (CIFAR-10) generated by each approach. The CIFAR-10 dataset (Canadian Institute For Advanced Research) includes 60,000 32×32 color images in 10 classes, with 6,000 images per class. There are 50,000 training images and 10,000 test images in the CIFAR-10 dataset.

The twelve (12) data protection approaches listed in the first row 110 of FIG. 1 include Neural Tangent Generalization Attacks (NTGA), Error-Minimizing (EMin), Error-Maximizing (EMax), Deep-Confuse (DC), Synthetic (Syn), Auto Regressive (AR), Robust Error-Minimizing (REM), One-Pixel Shortcut (OPS), Entangled-Features (EntF), Self-Ensemble Protection (SEP), Hypocritical (HYPO), and TensorClog (TC). These unlearnable data are crafted by adding imperceptible perturbation to the original data through the aforementioned twelve approaches, which are used to solve a bi-level optimization problem. FIG. 1 shows sample images in the second row 120 generated by each of the mentioned approaches, along with their corresponding perturbations in the third row 130. The perturbations are derived by subtracting the unlearnable image from the original one. The fourth row 140 in FIG. 1 presents the test accuracy of a model trained on an unlearnable CIFAR-10 dataset protected by each approach, or how similar the prediction image is to the original image. The test accuracy for a DNN model trained on a clean CIFAR-10 dataset is approximately 95%. The presence of unlearnability demonstrates a decrease in test accuracy, as depicted in FIG. 1, such that a lower test accuracy represents the obfuscated image being more unlearnable by the trained DNN.

Ensemble learning is a popular advanced machine-learning approach involving training multiple learners (e.g., models) and combining their outcomes to achieve enhanced performance and more generalization capabilities compared to their individual learners. Because of their high performance, ensemble learning methods are applicable regardless of the field. Unlearnable data is presumed to disrupt DNN training, leading to models with poor generalizability. On the other hand, ensemble learning methods are used to improve the generalizability of conventional models.

Ensemble learning is a critical concept in machine learning because it combines multiple models to improve the overall performance of a system. Instead of relying on a single model to make predictions, ensemble methods aggregate the predictions of multiple models, often leading to better accuracy, robustness, and generalization. However, applying ensemble learning unlearnable data is not straightforward. Instead, there are several major challenges. Some of these challenges include: (1) increased training and testing time, (2) model overfitting, (3) hyperparameter tuning difficulty, (4) data quality dependence, (5) struggling in ensemble selection and combination, and (6) data splitting bias in model training.

Accordingly, a need exists for advancing conventional ensemble learning to defeat the unlearnable data. In addition, a need exists for evaluating the efficacy of data obfuscation techniques for generating unlearnable data.

### SUMMARY

The following presents a simplified summary of the disclosed technology herein in order to provide a basic understanding of some aspects of the disclosed technology. This summary is not an extensive overview of the disclosed technology. It is intended neither to identify key or critical elements of the disclosed technology nor to delineate the scope of the disclosed technology. Its sole purpose is to present some concepts of the disclosed technology in a simplified form as a prelude to the more detailed description that is presented later.

In some aspects, example embodiments in accordance with the present disclosure can provide for advancing ensemble learning against unlearnable data, leveraging the advantages and techniques described herein.

In some aspects, the techniques described herein relate to a method for training a machine-learning model to break obfuscated image data, the method including: receiving an original image dataset including image data that is obfuscated to machine learning, and performing an ensemble machine-learning training framework including at least one of: a stacking ensemble framework including: applying a first nonlinear transformation to the original image dataset to generate a transformed stacking image dataset, training a plurality of pre-trained machine-learning stacking models with the transformed stacking image dataset, obtaining probability predictions for the original image dataset with each of the plurality of pre-trained machine-learning stacking models, training a meta-learner model with the obtained probability predictions as an independent variable and with the original image dataset as a target variable, generating test predictions from the trained meta-learner model with the transformed image dataset, determining a respective prediction test accuracy for each of the test predictions, and for each of the plurality of pre-trained machine-learning models, in response to the prediction test accuracy being greater than a target test accuracy, outputting a corresponding final stacked model prediction image dataset, a boosting ensemble framework including: applying a first nonlinear transformation to the original image dataset to generate a transformed boosting image dataset, training a first pre-trained machine-learning boosting model with the transformed boosting image dataset, obtaining boosting prediction images for the original image dataset from the first pre-trained machine-learning boosting model with the transformed boosting image dataset, selecting misclassified images from among the boosting prediction images, applying a second nonlinear transformation to the misclassified images to generate a transformed misclassified image dataset, the second nonlinear transformation being a different type from the first nonlinear transformation, combining the transformed misclassified image dataset with the transformed boosting image dataset to generate a boosted image dataset, training a next pre-trained machine-learning boosting model with the boosted image dataset, obtaining additional boosting prediction images for the original image dataset from the pre-trained machine-learning boosting model with the boosted image dataset, repeating the selecting, applying, combining, re-training, and obtaining of the boosting ensemble framework k times, such that k pre-trained machine-learning boosting models are trained and k sets of boosting prediction images are obtained, where k is an integer greater than two, each subsequent iteration of misclassified images being assigned a greater weight than a preceding iteration of misclassified images, and outputting a final boosting prediction image dataset from among the k sets of boosting prediction images by majority voting based on respective test accuracies for each of the k pre-trained machine-learning boosting models, or a bagging ensemble framework including: splitting the original image dataset into a plurality of overlapped split image data subsets, applying at least one of a plurality of nonlinear transformations to each of the overlapped split image data subsets to generate corresponding transformed bagging image data subsets, training a respective pre-trained machine-learning bagging model with each of the transformed bagging image data subsets, obtaining bagging prediction images for the original image dataset from each of the pre-trained machine-learning bagging models with the transformed bagging image data subsets, and outputting a final bagging model prediction image dataset by combining the bagging prediction images by majority voting based on respective test accuracies for each of the pre-trained machine-learning bagging models.

In some aspects, the techniques described herein relate to a non-transitory computer-readable medium for training a machine-learning model to break obfuscated image data, the non-transitory computer-readable medium storing instructions that, when executed by at least one processor of a computing system, cause the computing system to perform operations, the operations including: receiving an original image dataset including image data that is obfuscated to machine learning, and performing an ensemble machine-learning training framework including at least one of: a stacking ensemble framework including: applying a first nonlinear transformation to the original image dataset to generate a transformed stacking image dataset, training a plurality of pre-trained machine-learning stacking models with the transformed stacking image dataset, obtaining probability predictions for the original image dataset with each of the plurality of pre-trained machine-learning stacking models, training a meta-learner model with the obtained probability predictions as an independent variable and with the original image dataset as a target variable, generating test predictions from the trained meta-learner model with the transformed image dataset, determining a respective prediction test accuracy for each of the test predictions, and for each of the plurality of pre-trained machine-learning models, in response to the prediction test accuracy being greater than a target test accuracy, outputting a corresponding final stacked model prediction image dataset, a boosting ensemble framework including: applying a first nonlinear transformation to the original image dataset to generate a transformed boosting image dataset, training a first pre-trained machine-learning boosting model with the transformed boosting image dataset, obtaining boosting prediction images for the original image dataset from the first pre-trained machine-learning boosting model with the transformed boosting image dataset, selecting misclassified images from among the boosting prediction images, applying a second nonlinear transformation to the misclassified images to generate a transformed misclassified image dataset, the second nonlinear transformation being a different type from the first nonlinear transformation, combining the transformed misclassified image dataset with the transformed boosting image dataset to generate a boosted image dataset, training a next pre-trained machine-learning boosting model with the boosted image dataset, obtaining additional boosting prediction images for the original image dataset from the pre-trained machine-learning boosting model with the boosted image dataset, repeating the selecting, applying, combining, re-training, and obtaining of the boosting ensemble framework k times, such that k pre-trained machine-learning boosting models are trained and k sets of boosting prediction images are obtained, where k is an integer greater than two, each subsequent iteration of misclassified images being assigned a greater weight than a preceding iteration of misclassified images, and outputting a final boosting prediction image dataset from among the k sets of boosting prediction images by majority voting based on respective test accuracies for each of the k pre-trained machine-learning boosting models, or a bagging ensemble framework including: splitting the original image dataset into a plurality of overlapped split image data subsets, applying at least one of a plurality of nonlinear transformations to each of the overlapped split image data subsets to generate corresponding transformed bagging image data subsets, training a respective pre-trained machine-learning bagging model with each of the transformed bagging image data subsets, obtaining bagging prediction images for the original image dataset from each of the pre-trained machine-learning bagging models with the transformed bagging image data subsets, and outputting a final bagging model prediction image dataset by combining the bagging prediction images by majority voting based on respective test accuracies for each of the pre-trained machine-learning bagging models.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims or may be learned by the practice of such embodiments as set forth hereinafter.

### BRIEF DESCRIPTION OF THE DRAWINGS

To describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings.

FIG. 1 shows related art examples of unlearnable data techniques and corresponding single-learner model prediction results.

FIG. 2 is a workflow for an example stacking ensemble framework.

FIG. 3 is a workflow for an example boosting ensemble framework.

FIG. 4 illustrates an example framework by incorporating nonlinear transformations in the conventional bagging method.

FIGS. 5A-5F are graphs showing experimental results of test accuracy of each DNN model using a stacked ensemble framework in accordance with an example embodiment of the present disclosure.

FIG. 6 is a graph of the test accuracies of each model over boosting iterations in experimental results.

FIG. 7 is a set of graphs showing experimental results of memory usage on each model in the ensembles according to example embodiments.

FIG. 8 is a flowchart of an example method for training a machine-learning model to break obfuscated image data.

FIG. 9 is a flowchart of an example method for training a machine-learning model to break obfuscated image data.

FIG. 10 is a flowchart of an example method for training a machine-learning model to break obfuscated image data.

FIG. 11 is a flowchart of an example method for training a machine-learning model to break obfuscated image data.

FIG. 12 illustrates certain components that may be included within a computer system according to an example embodiment of the present disclosure.

Before explaining the disclosed embodiment of this disclosure in detail, it is to be understood that the invention is not limited in its application to the details of the particular arrangement shown, as the invention is capable of other embodiments. Example embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION

While the subject disclosure applies to embodiments in many different forms, there are shown in the drawings and will be described in detail herein specific embodiments with the understanding that the present disclosure is an example of the principles of the invention. It is not intended to limit the invention to the specific illustrated embodiments. The features of the invention disclosed herein in the description, drawings, and claims can be significant, both individually and in any desired combinations, for the operation of the invention in its various embodiments. Features from one embodiment can be used in other embodiments of the invention.

In the description of the drawings, like reference numerals refer to like elements.

The following description will provide a disclosure of various features, approaches, and aspects of example systems and methods that can overcome the limitations described above.

Described here are systems and methods directed to advancing ensemble learning against unlearnable data. The approaches described herein use algorithms for generating and for iteratively training machine-learning models to predict and reproduce unlearnable image data, but in a novel way that leverages nonlinear transformations in combination with ensemble learning to train machine-learning models on “unlearnable” obfuscated image data.

Example embodiments of the present disclosure may provide frameworks to advance conventional ensemble learning methods, including stacking, boosting, and bagging, for defeating data protection approaches by converting their generated unlearnable data into learnable ones. Example embodiments of the present disclosure may enhance and implement ensemble learning on the unlearnable data while incorporating nonlinear transformations.

Example embodiments of the present disclosure may use three primary ensemble learning methods: stacking, boosting, and bagging. Example embodiments of the present disclosure may apply the three methods, alone or in combination, respectively, to unlearnable data.

Example frameworks may include several advantages compared to conventional ensemble learning methods. For example, in the boosting method, the significance of misclassified data may be amplified by employing nonlinear transformations. For example, in the stacking method, examples may leverage models with diverse DNN architectures, recognizing that unlearnable data may display varying performance characteristics depending on the architecture employed. For example, in the bagging method, overlapping subsets may be selected to expand the training data, effectively mitigating potential overfitting issues in individual models induced by unlearnability.

Example embodiments of the present disclosure may include three new ensemble learning frameworks corresponding to these three conventional ensemble learning techniques, which leverage nonlinear transformations to improve conventional ensemble learning methods for breaking the unlearnable data. The example frameworks result in model ensembles with enhanced generalization capabilities. For instance, in the proposed boosting framework, greater weights should be assigned to misclassified units from the preceding model. Example embodiments may achieve this by generating additional images through various nonlinear transformation techniques.

The present disclosure will now provide overview descriptions of various approaches to deploying embodiments of such systems and methods. It should be understood that the processes and algorithms described below are not limiting of the scope of this disclosure, can be combined in various configurations, and may be adapted to replace, complement, and/or fit with existing platforms for image-based diagnoses.

Unlearnable data are crafted using availability attacks, also known as generalization attacks. Generalization attacks aim to craft imperceptible perturbations, 6, for all images in a training set by solving the following optimization problem shown in Equations 1 and 2, where Equation 1 is subject to Equation 2:

$${arg max}_{{‖ δ ‖}_{p} \leq ϵ} [ ℒ ( f ( {X}_{v} ; {θ}^{*} ) , {Y}_{v} ) ] \qquad [ Equation 1 ]$$

$${θ}^{*} ∈ {arg min}_{θ} [ ℒ ( f ( {X}_{T} + δ ; θ ) , {Y}_{T} ) ] \qquad [ Equation 2 ]$$

X_{T} and Y_{T} represent sets of input images and target labels in the training set respectively.

Similarly, Xᵥ and Yᵥ denote sets of images and target labels in a validation set, respectively. 6 is a set of perturbation that is added to the set of input images X_{T}. The DNN model ƒ with a set of parameters, θ, has a loss function of L. Equation 2 finds the optimal set of parameters, θ*, that minimizes the training loss, indicating that the model is well-trained. Equation 1 searches for perturbation δ that leads to high validation losses, which makes it difficult for the model to provide precise results on unknown data without perturbations (e.g., clean data). The perturbations are anticipated to be smaller than ϵ, ensuring they remain unnoticeable.

In ensemble learning, multiple learners (e.g., machine-learning models) work together to solve a single problem. The main objective of an ensemble learning process is first training a set of individual learners, and then combining their training outputs/results using some. That is, ensemble learning methods can be formulated as follows in Equation 3:

$${arg min}_{G} [ ℒ ( G ( {f}_{1} ( {X}_{v} ) , {f}_{2} ( {X}_{v} ) , … {f}_{k} ( {X}_{v} ) ) , {Y}_{v} ) ] \qquad [ Equation 3 ]$$

G∈ [symbol] represents an aggregator, which is a mechanism to combine models ƒ₁, ƒ₂, . . . ƒₖ together. [symbol] denotes a set of all the mechanisms that combines models ƒ₁,ƒ₂, . . . ƒₖ. Here, Xᵥ and Yᵥ denote the sets of images and target labels in the validation set, respectively. [symbol] means the loss function. The goal of the above optimization problem is to discover the aggregator G that results in a minimal loss.

There are three fundamental ensemble learning methods: stacking, boosting, and bagging. (1) The stacking method uses different algorithms on the same training dataset. Thus, different algorithms can be trained in parallel and the predictions can be obtained from each model. To combine the predictions obtained from each model, a meta-learner is used. As it learns from the predictions of different algorithms, the meta-learner may be simple. Therefore, linear classifiers, such as logistic regression, may be used as meta-learners. (2) The boosting method uses the input data (X_{T}) to first train a weak classifier. Then, the predictions of the weak classifier are then compared with the true labels (Y_{T}), and misclassified training samples are selected. Next, misclassified samples are assigned higher weights than other samples in the dataset, so that the next model pays more attention to these samples during training. (3) The bagging method divides the dataset into subsets. The dividing may be random. After several subsets are generated, base learners (models) are respectively trained independently on each subset. A more accurate estimate is obtained based on the average or the majority of these predictions, depending on the task, e.g., regression or classification.

The frameworks for the three ensemble methods are standalone and may be implemented independently, as described later. However, example embodiments may select a base model with superior performance for boosting and bagging. The stacking method may be employed to aid in determining the most appropriate model for other approaches.

Based on the mathematical expression of ensemble learning methods given in Equation 3, this research further articulated the goal of improving ensemble learning methods against unlearnable data as follows in Equations 4, 5, and 6, in which Equation 4 is subject to Equation 5, which is further subject to Equation 6:

$${arg min}_{G} [ ℒ ( G ( {f}_{1}^{*} ( {X}_{v} ) , {f}_{2}^{*} ( {X}_{v} ) , … {f}_{k}^{*} ( {X}_{v} ) ) , {Y}_{v} ) ] \qquad [ Equation 4 ]$$

$${A}^{*} , {f}_{i}^{*} ∈ {arg min}_{A , {f}_{i}} [ {max}_{{‖ δ ‖}_{p} \leq ϵ} [ ℒ ( {f}_{i} ( {X}_{v} ; {θ}^{*} ) , {Y}_{v} ) ] ] \qquad [ Equation 5 ]$$

$${θ}^{*} ∈ {arg min}_{θ} [ ℒ ( {f}_{i} ( A ( {X}_{T} + δ ) ; θ ) , {Y}_{T} ) ] \qquad [ Equation 6 ]$$

for any given A⊆ [symbol] , where [symbol] represents a set of all the nonlinear transformation techniques applied to the unlearnable training dataset to mitigate the effects of unlearnable perturbations. The term “ƒᵢ” denotes a DNN model with a set of parameters θ.

Equations 4, 5, and 6 present a three-level optimization problem including three minimization problems and one maximization problem. To solve for G, an example methodology may use a bottom-up approach, e.g., by starting from its lowest-level, or its second-level constraint and then move it up. That is, experiments using example embodiments found the maximal space of variables in the sub-optimization problem given in the constraint of an optimization problem before solving the (original) optimization problem.

First, in Equation 6, ƒᵢ and A were fixed. Equation 6 aims to identify the optimal set of model parameters, θ*, by training a given DNN model, ƒ₁, on the unlearnable dataset augmented using one or more given nonlinear transformation techniques in a subset of [symbol] . Second, when moved to the next level constraint or the first-level constraint, Equation 5 found two outputs: (1) the optimal model architecture ƒᵢ*; and (2) the optimal subset of nonlinear transformation techniques, A*. These were chosen by evaluating θ* in the maximal space of variables generated by Equation 6, for a given ƒᵢ and A on a validation set. Equation 5 Equation 5 found the f and A that gave the minimum validation loss. This meant the highest generalizability. To obtain the desired DNN models ƒ₁*,ƒ₂*, . . . , ƒₖ* for the ensemble, this process would be repeated several times. Finally, Equation 4 was used to find the aggregator G∈ [symbol] , where [symbol] represented a set of all the mechanisms that combined the individual models fz* to achieve better accuracy than the individual models alone. Thus, a goal for solving the three-level optimization problem was to find A*, ƒᵢ*, and G under the three ensemble learning methods: stacking, boosting, and bagging.

Solving the above three-level optimization problem was not straightforward. In fact, it was a challenging task since it involved four complex sub-optimization problems. Let N be the total number of all nonlinear transformations. Then, the dimension of [symbol] 32 2^{N}. As such, the dimension of [symbol] was increasing exponentially with N. This implies that the above three-level optimization problem in Equations 4-6 had a parameter space with a very high dimension that was increasing exponentially with N, so it was extremely time consuming to search for an optimal solution of the optimization in the parameter space, which could not be done in polynomial time. Therefore, example embodiments provide a heuristic approach to making such searching feasible so that the approach could be used in real-world applications. That is, the resulting solution may be sub-optimal rather than optimal.

To avoid searching for each element in the parameter space of [symbol] that required exponential time, an optimal-expanding approach was developed in experiments. This approach may first select nonlinear transformations, e.g., grayscale, erode, dilate, and pixel manipulation, as [symbol] instead of all nonlinear transformations, and identified which nonlinear transformation can produce the highest test accuracy of training models. Such a nonlinear transformation may be used to form a base set. Each element of [symbol] may be a single nonlinear transformation rather than a subset of nonlinear transformations in [symbol] , e.g., [symbol] ⊏ [symbol] and [symbol] may have a much lower dimension than [symbol] . Next, the rest of the nonlinear transformations in [symbol] may be selected one-by-one, and which nonlinear transformation could achieve the highest test accuracy of training models may be identified, along with the base set. If the highest test accuracy is higher than the previously highest accuracy, then the new nonlinear transformation may be added to the base set. That is, this step may expand the base set. The above process may be continued until all the elements in [symbol] are checked. The resulting set may be a solution for A*. Let the dimension of [symbol] be n. Thus, the above optimal-expanding approach had the time complexity of n+(n−1)+ . . . +1=O(n²), which was in quadratic polynomial time in experiments.

Algorithm 1 is shown below, and is for selecting nonlinear transformation techniques. Algorithm 1 outlines the steps of finding A*. At the beginning of the process, A was an empty set, and V₀ represented the validation accuracy of the model trained on the unlearnable dataset (U). Algorithm 1 first randomly chooses a nonlinear transformation technique from the set [symbol] , and named it A₁. In general, the nonlinear transformation chosen at the it iteration is denoted as Aᵢ. Then, the transformation is applied to the unlearnable dataset, which is denoted by the notation Aᵢ(U). Next, a DNN model was trained on the transformed dataset, Aᵢ(U), and the validation accuracy Vᵢ was obtained. If the validation accuracy improved due to the transformation, Aᵢ was added into the set of A. The next iteration chose Aᵢ₊₁ from the set [symbol] \{A₁, . . . , Aᵢ}, e.g., the transformations selected in the previous iterations are removed from [symbol] before the next transformation is chosen. That is, this algorithm selects transformations without any replacement. After repeating this process for a specified number of iterations n, e.g., the dimension of [symbol] , the resulting set A was chosen as A*.

[Algorithm 1]

| for i = 1 to n do | | |
|---|---|---|
| \| | 1. | Randomly select Aᵢ from [symbol] \{A₁, . . . , Aᵢ₋₁}. |
| \| | 2. | Transform unlearnable dataset. U → Aᵢ(U) |
| \| | 3. | A(U) ← A(U) ∪ Aᵢ(U) |
| \| | 4. | Train a DNN model using A(U) and obtain |
| \| | validation accuracy (Vᵢ). | |
| \| | 5. | if Vᵢ > Vᵢ₋₁ then |
| \| | \| | A ← A ∪ Aᵢ |

| | |
|---|---|
| \| | end |

end
return A

When selecting fᵢ*, various pre-trained DNN architectures may be employed, such as Residual Network (ResNet) and Visual Geometry Group (VGG). The selected pre-trained DNN architectures may be further modified, for example, by adding additional layers and dropout layers, adjusting the number of neurons, changing the number of epochs, and tuning other hyperparameters. In experimental trials, the hyperparameters were selected based on the final test accuracy of the ensemble.

To solve the above three-level optimization, an aggregator G may be selected from a set of all aggregator mechanisms [symbol] under each ensemble learning method. This may incorporate the default aggregators used in conventional ensemble learning methods directly, without going through an optimization procedure. For instance, in an experiment, a meta-learner was utilized as the aggregator for the stacking method because different model architectures were included in the stacking ensemble. In experimental results, different architectures led to significant differences in model performance.

A meta-learner in a stacking method may determine which models were reliable and which were not, rather than a voting mechanism. In contrast, bagging and boosting methods may use a voting mechanism as an aggregator. In experiments, these methods incorporated the same model architecture for all models, but used different input data. In contrast to the stacking method, no significant difference in the performance of the individual models was observed in experiments. Instead of using a meta-learner as an aggregator, example bagging and boosting frameworks may employ a voting mechanism.

### Stacking Ensemble Against Unlearnable Data

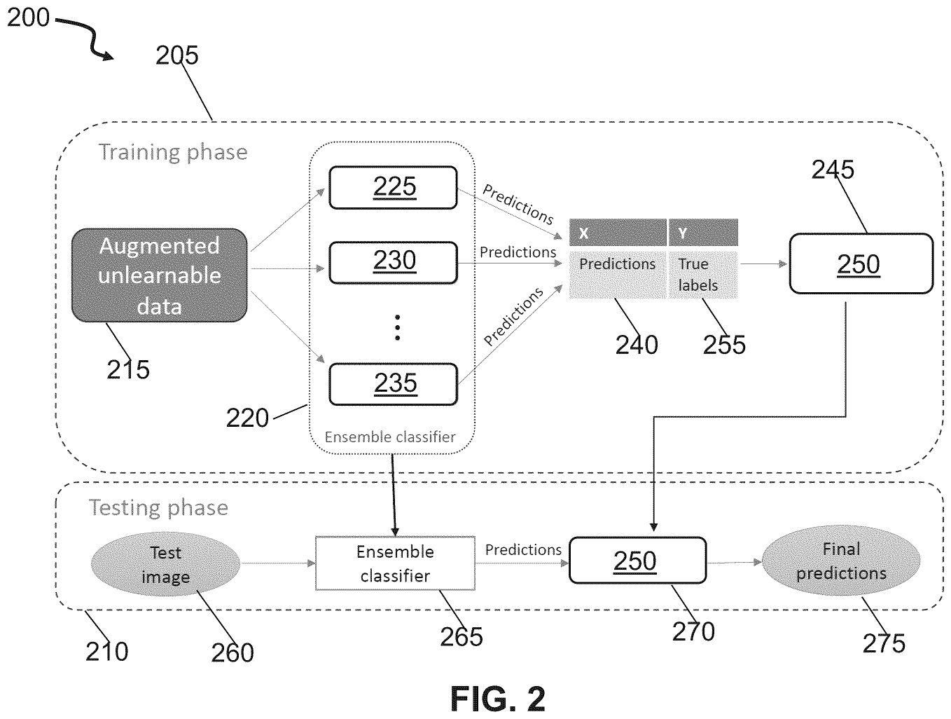

FIG. 2 is a workflow for an example stacking ensemble framework.

An example stacking ensemble framework 200 is shown in FIG. 2. The example stacking ensemble framework 200 may include a training phase 205 and a testing phase 210. The training phase 205 may include first augmenting the unlearnable training dataset, e.g., using nonlinear transformation techniques, in block 215. Some example nonlinear transformation techniques may include grayscaling, eroding, dilating, and pixel manipulation. Next, in an ensemble classifier generation operation at block 220, multiple pre-trained machine-learning models 225, 230, 235, which may be, for example, DNN models, each with different architectures, may be respectively trained on the augmented training dataset. Some nonlimiting examples of pre-trained DNN models may include Visual Geometry Group (VGG), e.g., VGG16 and VGG19, and Residual Network (ResNet). Example embodiments are not limited in type or number to the machine-learning models 225, 230, 235 illustrated in block 220. Next, at block 240, predictions may be made on the unlearnable training set using the machine-learning models 225, 230, 235 that were trained at block 220. The predictions may be obtained in terms of probabilities, not target classes, although embodiments are not limited thereto. Then, at block 245, a meta-learner 250, e.g., a logistic regression model, may be fitted considering these predicted probabilities as independent variables (X) and the true labels 255 as a target variable (Y). While logistic regression may be used as the meta-learner in some example stacking methods, embodiments are not limited thereto.

In the testing phase 210, the example framework 200 may obtain respective sets of predictions for each of one or more test images 260 using a stacking ensemble classifier 265, which includes each trained machine-learning model 225, 230, 235 in the ensemble that was generated at block 220 of the training phase 205. These predictions (in terms of probabilities) may be fed into the trained meta-learner 250, e.g., a logistic regression model, at block 270. The output of the meta—learner 250 may then be a final prediction given by the ensemble at block 275, in which the meta-learner 250 may output a final prediction image (for each originally-input test image) based on which prediction it determined to be the most accurate, e.g., with the highest probability. The meta-learner may also identify which prediction is the most accurate, e.g., has the highest percentage of similarities with the original test image(s), and may evaluate which of the trained machine-learning models 225, 230, 235 of the stacking ensemble classifier 265 is the most effective at breaking the unlearnable data type of the test image(s).

[Algorithm 2]

| Data: | | Unlearnable training images (T), Pretrained |
|---|---|---|
| | | models (M₁, M₂, . . . , Mₖ), Number of |
| | | iterations (k), Nonlinear transformation |
| | | techniques (A), Clean test dataset, Target |
| | | test accuracy (α) |
| Result: The stacking ensemble | | |
| Augment T and create T₁ (T₁ ← A(T)); | | |
| for i ← 1 to k do | | |
| \| | 1.Train several pretrained models M₁, . . . , Mᵢ on | |
| \| | T₁; | |
| \| | 2. | Make predictions on T using M₁, . . . , Mᵢ; |
| \| | 3. | Train a logistic regression model L by |
| \| | considering predictions as feature variables (X) | |
| \| | and true labels of T as target variables (Y); | |
| \| | 4. | Generate test predictions and calculate test |
| \| | accuracy (d); | |
| \| | if d > α then | |
| \| | \| | STOP |

| | |
|---|---|
| \| | end |

end
return {M₁, M₂, . . . , Mₖ} ∪ L

As shown in Algorithm 2, which is an example stacking ensemble framework, the different DNN models may be added to the ensemble one-by-one until the ensemble reaches a desired test accuracy. Due to the unlearnability, the performance of the individual models varied greatly in experiments, depending on the architecture. Therefore, the individual performance of the model may be a concern when selecting the model for the ensemble.

In a stacking ensemble in accordance with an example embodiment of the present disclosure, one point of novelty is in applying nonlinear transformation techniques and utilizing diverse DNNs architectures. As such, a stacking ensemble in accordance with an example embodiment may address the vulnerabilities of unlearnable data to data transformations and different model architectures simultaneously. In addition, a stacking ensemble in accordance with an example embodiment may overcome the challenge of balancing the diversity among individual models while maintaining accuracy. Although both nonlinear transformations and diverse architectures have been explored separately in past research on unlearnable data, example embodiments combine them to achieve significantly better performance.

### Boosting Ensemble Against Unlearnable Data

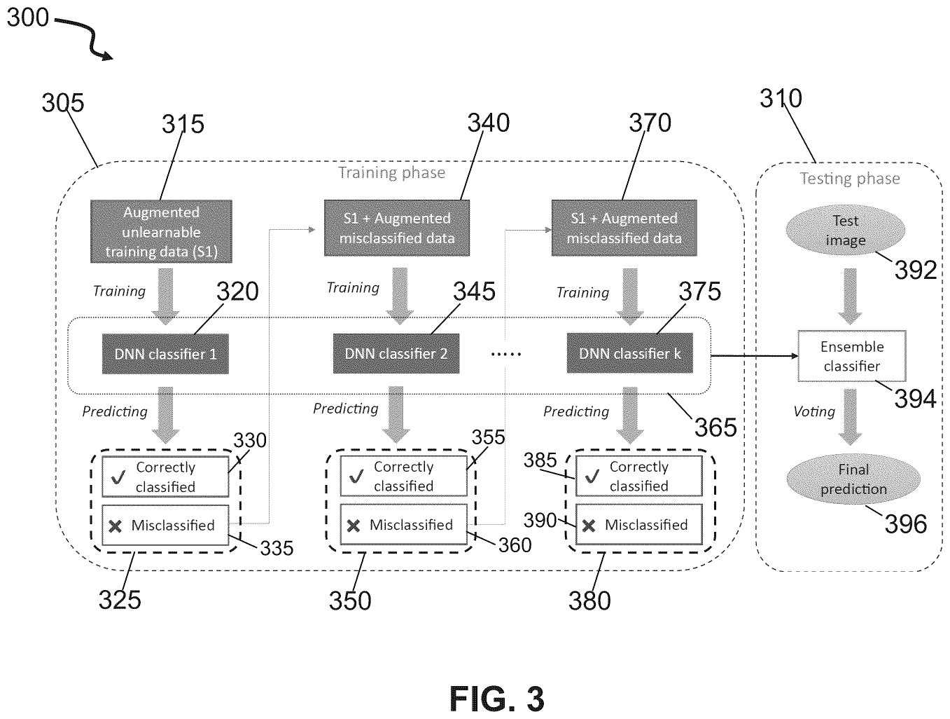

The boosting ensemble method sequentially creates a series of models that focus on the samples misclassified by a previous model when training a next model. All samples may be assigned the same weight at the beginning of the process. In each iteration, the weights of the misclassified samples may be increased. This may cause each subsequent model to pay more attention to the misclassified samples than to other samples. An example boosting framework leverages nonlinear transformations with a boosting ensemble method, as illustrated in FIG. 3.

FIG. 3 is a workflow for an example boosting ensemble framework.

An example boosting ensemble framework 300 is shown in FIG. 3. The example boosting ensemble framework 300 may include a training phase 305 and a testing phase 310. The training phase 305 may include first, at block 315, using nonlinear transformation techniques to augment an original unlearnable training dataset to generate a first augmented unlearnable training dataset, e.g., Si. Some example nonlinear transformation techniques may include grayscale, erode, dilate, and pixel manipulation. These transformation techniques may to mitigate the unlearnability of the training data. Next, at block 320, a pre-trained machine-learning model, e.g., a DNN model, may be trained using the first augmented unlearnable training dataset. A nonlimiting example of pre-trained DNN model may include VGG. A number of training epochs may be selected to ensure that the model is not overfitted. Using the trained machine-learning model, predictions may be made at block 325 on the first augmented unlearnable training dataset to identify samples that are correctly-classified (330) and misclassified (335). At block 340, the misclassified samples 335 may be augmented and combined with the first augmented unlearnable training dataset, e.g., Si, to generate a new augmented training dataset, e.g., S₂. As a result, misclassified samples may be repeated in the new augmented training dataset more than the other samples, so they may be amplified in the next model, which may give the misclassified samples more weight than in the training of the previous model. Next, the new augmented training dataset may be used to train another pre-trained DNN model at block 345. Then, at block 350, the new trained model may make predictions on the original unlearnable training dataset to identify samples that are correctly-classified (355) and misclassified (360). The augmentation-prediction process of blocks 340, 345, and 350 may be repeated for k times, resulting in an ensemble model with k models 365, where k is an integer greater than two.

For example, at block 370, the misclassified samples from a previous prediction, e.g., misclassified samples 335 from block 350, may be augmented and combined with the previous augmented unlearnable training dataset, e.g., S₂, to generate a k^{th} augmented training dataset, e.g., Sₖ. Next, the k^{th} augmented training dataset may be used to train a k^{th} pre-trained DNN model at block 375. Then, at block 380, the ktl trained model may make predictions on the original unlearnable training dataset to identify samples that are correctly-classified (385) and misclassified (390).

In the testing phase 310, a test image dataset 392, which may include one or more test images, may be input at block 394 to a boosting ensemble classifier including the k trained models 365 to obtain a predicted class of each image in the test image dataset 392. Based on voting of the predictions given by all k trained models 365, a final prediction image (or image dataset) may be generated at block 396. The example boosting ensemble framework 300 may determine a number of boosting iterations k based on the final test accuracy. The boosting ensemble classifier may also identify which prediction is the most accurate, e.g., has the highest percentage of similarities with the original test image(s), and may evaluate which of the k trained models 365 of the boosting ensemble classifier is the most effective at breaking the unlearnable data type of the test image(s).

Algorithm 3 below is an example boosting ensemble framework. Algorithm 3 provides an example training procedure for obtaining the boosting ensemble.

[Algorithm 3]

| Data: | | Unlearnable training images (T), Pretrained |
|---|---|---|
| | | model (M), Number of iterations (k), |
| | | Nonlinear transformation techniques (A) |
| Result: The boosting ensemble | | |
| Augment T and create S₁ (S₁ ← A(T)); | | |
| for i ← 1 to k do | | |
| \| | 1. | Train pretrained model M using Sᵢ to obtain |
| \| | model Mᵢ; | |
| \| | 2. | Make predictions on T using Mᵢ; |
| \| | 3. | Select misclassified images (Dᵢ) and make |
| \| | additional augmented images A(Dᵢ); | |
| \| | 4. | Combine additional images with original |

| | |
|---|---|
| \| | training set (Sᵢ₊₁ ← Sᵢ + A(Dᵢ)); |

end
return {M₁, M₂, . . . , Mₖ}

In an example boosting ensemble, one important contribution lay in how the weights of misclassified images are increased. However, simply increasing the weight of an image may not help when the images were unlearnable. As such, training on the images may be repeated with different transformations. This approach may mitigate overfitting caused by unlearnable data, as well as excessive training in ensemble learning. To avoid making the process overly complex and to prevent high execution time, the same transformations were applied in each iteration in an experiment. The hyperparameters, such as number of epochs, were also carefully tuned to reduce overfitting in the experiment.

### Bagging Ensemble Against Unlearnable Data

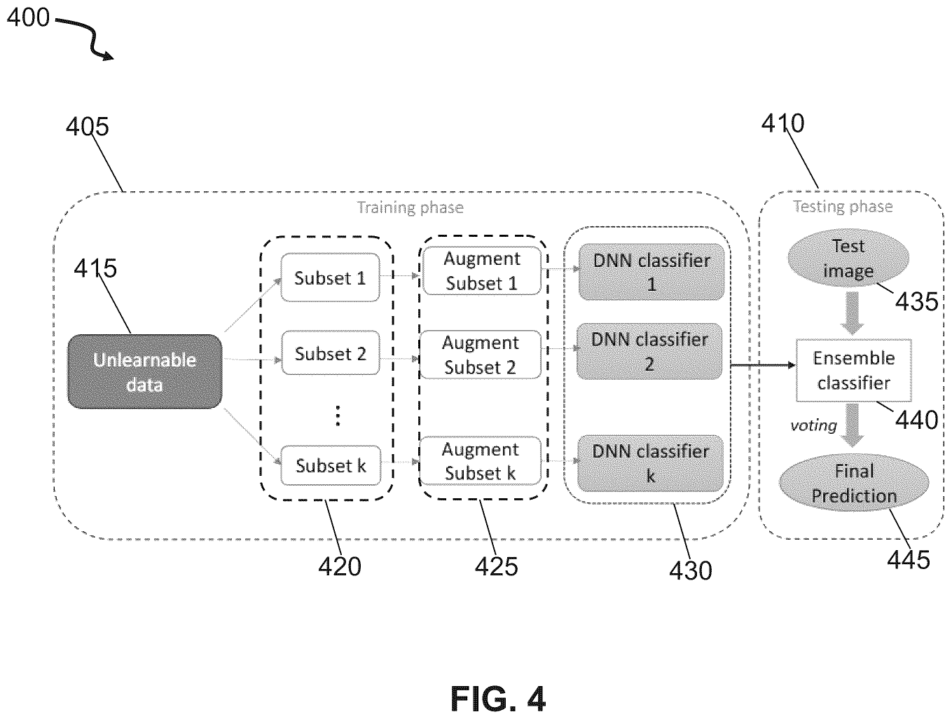

An example bagging framework in accordance with an embodiment of the present disclosure modifies the conventional bagging ensemble method for successful use against unlearnable data. First, an example bagging framework in accordance with an embodiment of the present disclosure splits the training data, e.g., using random sampling, to generate k different subsets. A machine-learning model, e.g., a DNN model, may be trained on each subset, resulting in k models. The k models may be combined, for example, using majority voting, to obtain a strong classifier, e.g., as a bagging model prediction image dataset. It should be appreciated that the value of “k” used in the example bagging framework is not necessarily the same as the value of “k” used in the example boosting framework described above. FIG. 4 illustrates an example framework by incorporating nonlinear transformations in the conventional bagging method.

FIG. 4 is a workflow for an example bagging ensemble framework.

An example bagging ensemble framework 400 is shown in FIG. 4. The example bagging ensemble framework 400 may include a training phase 405 and a testing phase 410. The training phase 405 may include first dividing an original unlearnable training dataset 415 into overlapping subsets (e.g., Subset 1, Subset 2, . . . Subset k) at block 420. The K subsets may be balanced. A percentage of overlap among the subsets may be increased to determine an optimal overlap percentage. Next, at block 425, the example bagging ensemble framework 400 may augment each respective subset with one or more nonlinear transformation techniques to generate k augmented subsets (e.g., Augment Subset 1, Augment Subset 2, . . . Augment Subset k). Some nonlimiting examples of nonlinear transformation techniques include grayscale, pixel manipulation, erode, and dilate. Then, at block 430, a respective pre-trained machine-learning model, which may be, for example, a DNN model, such as VGG19 as a nonlimiting example, may be trained on each augmented subset.

In the testing phase 410, a test image dataset 435, which may include one or more test images, may be input at block 440 to a bagging ensemble classifier that includes the k trained machine-learning models of block 430 (e.g., DNN classifier 1, DNN classifier 2, . . . DNN classifier k) to obtain a predicted class of each image in the test image dataset 435. Based on voting of the predictions given by all k trained models of block 430, a final prediction image (or image dataset) may be generated at block 445. The example bagging ensemble framework 400 may optimize the machine-learning model architecture based on a final test accuracy. The bagging ensemble classifier may also identify which prediction is the most accurate, e.g., has the highest percentage of similarities with the original test image(s), and may evaluate which of the k trained models 365 of the bagging ensemble classifier is the most effective at breaking the unlearnable data type of the test image(s).

Algorithm 4 below is an example bagging ensemble framework. Algorithm 4 shows an example procedure for building the bagging ensemble. The testing phase, e.g., 410 in FIG. 4, may collect predictions from each trained model and derive the final prediction using a majority voting approach.

[Algorithm 4]

| Data: | | Unlearnable training images (T), Pretrained |
|---|---|---|
| | | model (M), Number of subsets (k), |
| | | Nonlinear transformation techniques (A), |
| | | Overlap percentage (p) |
| Result: The bagging ensemble | | |
| Split the training set into k subsets T₁, T₂, . . . Tₖ | | |
| with an overlap percentage of p; | | |
| for i ← 1 to k do | | |
| \| | 1. | Augment Tᵢ subset (T′ᵢ ← A(Tᵢ)); |
| \| | 2. | Obtain model Mᵢ by training pretrained |

| | |
|---|---|
| \| | model M on T′ᵢ subset; |

end
return {M₁, M₂, . . . , Mₖ}

In a bagging ensemble in accordance with an example embodiment of the present disclosure, one point of novelty is in the addition of overlapping subsets while improving the variations in the data. In experiments using the example bagging ensemble method, a challenge was in that the models did not have unique training images to learn from. To address this bias in data splitting, the original images are modified using nonlinear transformations, and overlapping subsets are implemented. This approach addresses multiple challenges posed by unlearnable data simultaneously. Balanced subsets may be used in example embodiments, which may ensure that even the overlapping data portions remained balanced.

Example embodiments may use various nonlinear transformation techniques, for example, erode, dilate, grayscale, and pixel manipulation with respect to channels, e.g., color channels, which may be three color channels, e.g., red (R), green(G), and blue (B). Erode and dilate transformations are morphological operations that use kernel functions to process images. These operations may allow nonlinear perturbations to be captured by applying a structuring element to an image. The erode transformation may reduce the boundaries of bright regions, while the dilate transformation may expand them. These transformations may effectively emphasize or suppress certain features in an image, making them useful for capturing complex, nonlinear changes in pixel intensity. On the other hand, pixel manipulation and grayscale transformations may focus on simplifying and reducing the complexity of the image's color channels. These transformations may convert the image from color (e.g., RGB) to a single intensity value, which may effectively reduce the information in the three color channels to one. By replacing the values of all three color channels of each pixel with a single value, these transformations may diminish the impact of channel-wise perturbations. Experiments implemented three transformation techniques under pixel manipulation based on which color channel value (e.g., R, G, or B) was used for replacement.

Ensemble learning methods demand substantial training and testing time because they involve multiple models. To address this issue, extensive experiments were conducted to look for a number of epochs to trade balance accuracy and training time. Experimental results concluded that the number of training epochs should be limited to no more than 35. Model overfitting may be expected when dealing with unlearnable data. By limiting the training epochs, the tendency for overfitting in the models was also reduced in experiments. Through a lot of experiments, the choice of hyperparameters, such as model architectures, nonlinear transformations, and learning rates, were tuned and finalized. Because of the complexity of the hyperparameter selection, the experiments employed example stacking, boosting, and bagging frameworks to attempt to find a useful set of suboptimal hyperparameters. Through many experimental trials, the same nonlinear transformations were chosen across all models in the ensemble learning. The experiments found that the VGG19 model architecture was the most effective for the bagging and stacking ensembles employed in example embodiments. Example frameworks may be independent of any particular dataset. In experiments, only the hyperparameters were tailored to the specific datasets. The experiments demonstrated this by applying example frameworks to diverse datasets, including CIFAR-10, ImageNet, MNIST, and CIFAR-100. Ensemble learning, even without augmentation, has not been applied to unlearnable data. Because ensemble learning includes different types and there were a variety of models available, the choice of which ensemble method to be used was challenging in the experimental process. An example bagging ensemble framework may mitigate bias by splitting datasets class-wise and introducing overlapping splits.

### Example Implementations and Experiments

The example ensemble learning frameworks were evaluated by the inventors on unlearnable CIFAR-10 datasets crafted by the above twelve (12) existing approaches, which include NTGA, EMin, EMax, DC, Syn, AR, REM, OPS, EntF, SEP, HYPO, and TC. The inventors chose to conduct their experiments using the TensorFlow framework for its versatility and the availability of pre-trained DNN models with diverse architectures.

The inventors incorporated nonlinear transformation techniques (A) due to their effectiveness against various unlearnable datasets compared to other methods. Therefore, the inventors restricted the set of nonlinear transformation techniques [symbol] to six (N) nonlinear transformations. The set of nonlinear transformation techniques [symbol] used in the experiments were grayscale, three pixel manipulation techniques with respect to three color channel values, erode, and dilate. The inventors began their search for A* with the set of nonlinear transformations A, with respect to each dataset. Then, the inventors further modified A by adding or removing nonlinear transformation techniques in [symbol] one-by-one, based on the final validation accuracy of the ensemble. After several rounds of trial and error, the inventors chose the A that gave the highest final validation accuracy as A*. The inventors implemented these transformations using functions from the OpenCV library. Grayscale conversion and pixel manipulation were performed through functions available in OpenCV for modifying pixel values (https:1/docs.opencv.org/4.x/d3/df2/tutorial_py_basic_ops.html). As an example, the inventors replaced all channel values with the same color channel value, resulting in a gray image with enhanced brightness in areas containing pixels with the selected color channel. Erode transformation was performed with cv.erode to expand darker areas of the image, while dilate transformation, performed with cv.dilate, expanded lighter areas.

### Experiments Using the Stacking Ensemble

In the proposed stacking framework, the inventors trained different model architectures on the augmented unlearnable data. Pre-trained DNN models, VGG19, VGG16, ResNet50, and ResNet101 from the Tensorflow Keras Applications (https://keras.io/api/applications/), were selected. The inventors also built Extended-VGG19/16 models by adding four fully connected layers of 1024, 512, 128, and 64 neurons, respectively, using the ReLU activation function. For all the models, the last layer was a fully connected layer with ten neurons and a SoftMax activation function because there were ten output classes. The inventors trained the models for up to 35 epochs to avoid overfitting. The nonlinear transformation techniques used included pixel manipulation, grayscale, erode, and dilate. As a meta-learner, we employed the most commonly used learner, logistic regression, from the Scikit-learn library. Specifically, the inventors utilized the liblinear solver for the logistic regression model, based on their experimental trials. Table 1 below summarizes the performance of the inventors' proposed stacked ensembles trained on each unlearnable dataset including the DNN models used for each ensemble. The test accuracies of example stacking ensembles trained in experiments on unlearnable CIFAR-10 datasets are presented in Table 1. In Table 1, the inventors present the average test accuracy after repeating the experiments for five times. The second column specifies the DNN model architectures in the experimental stacking ensemble. The baseline shown in Column 2 gives the test accuracy obtained using ResNet50 with the same nonlinear transformations. Column 2 of Table 1 shows the test accuracy under a baseline. For the baseline, the inventors chose a pretrained ResNet50 model because the ResNet architecture is one of the most commonly used surrogate models for creating unlearnable perturbations. The inventors also applied the same nonlinear transformation techniques to the baseline as they used the stacking ensemble to demonstrate the impact of the ensemble. The proposed stacking ensembles achieved more than 89% on all twelve approaches representing a significant improvement over the baseline.

TABLE 1

| Unlearnable | Baseline | | Test |
|---|---|---|---|
| dataset | (ResNet50) | Models in the ensemble | accuracy |
| NTGA | 65.11% | VGG19/VGG16/ExtendedVGG19 | 90.17 ± 0.15% |
| EMin | 73.88% | VGG19/VGG16/ExtendedVGG19/ResNet101 | 90.15 ± 0.21% |
| EMax | 66.18% | VGG19/VGG16/ExtendedVGG19 | 90.30 ± 0.25% |
| DC | 62.84% | VGG19/VGG16/ExtendedVGG16/ResNet50 | 90.17 ± 0.07% |
| Syn | 59.52% | VGG19/VGG16/ExtendedVGG19 | 90.11 ± 0.34% |
| AR | 71.37% | VGG19/VGG16/ExtendedVGG19/ResNet101 | 90.00 ± 0.71% |
| REM | 69.13% | VGG19/VGG16/ExtendedVGG16/ResNet50 | 89.07 ± 0.55% |
| OPS | 51.09% | VGG19/VGG16/ExtendedVGG19/ResNet50 | 89.71 ± 0.35% |
| EntF | 60.75% | VGG19/VGG16/ExtendedVGG16/ResNet50 | 90.96 ± 0.13% |
| SEP | 49.34% | VGG19/VGG16/ExtendedVGG16/ResNet50 | 89.89 ± 0.17% |
| HYPO | 67.99% | VGG19/VGG16/ExtendedVGG16/ResNet50 | 91.37 ± 0.14% |
| TC | 80.24% | VGG19/VGG16/ExtendedVGG16/ResNet50 | 89.46 ± 0.26% |

In these experiments, the inventors set the target accuracy (a) in Algorithm 1 to 90%, or to 89% if the algorithm could not reach 90%. Therefore, the inventors' framework consistently achieved 90% or 89% accuracy in the experiments. However, a should be adjusted based on the data set and the expected performance of the ensemble. For example, a was set to 98% for the MNIST dataset because the MNIST dataset is a simple dataset, and it is known to achieve high test accuracy. In general, a should be a realistic target test accuracy that can be achieved by training on a given dataset.

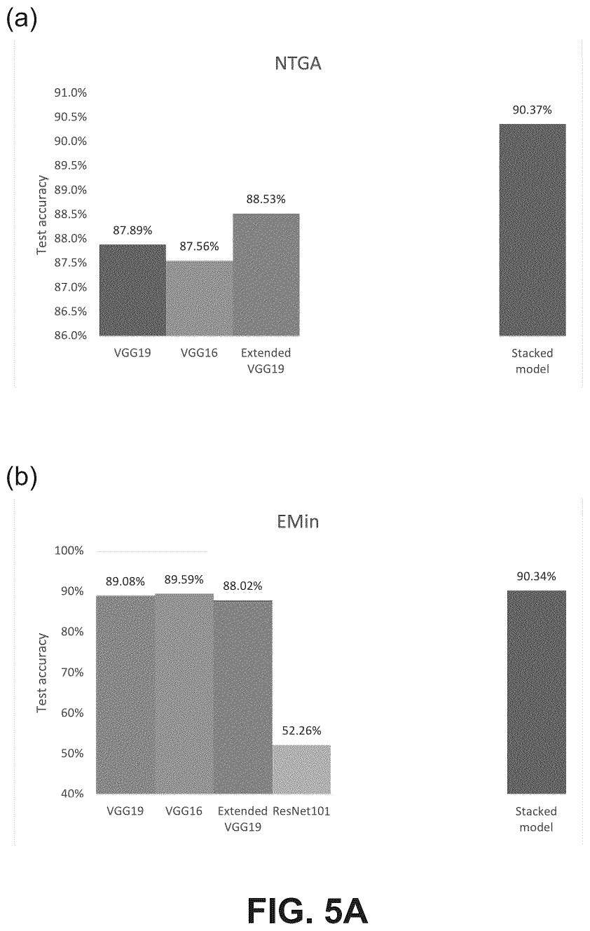

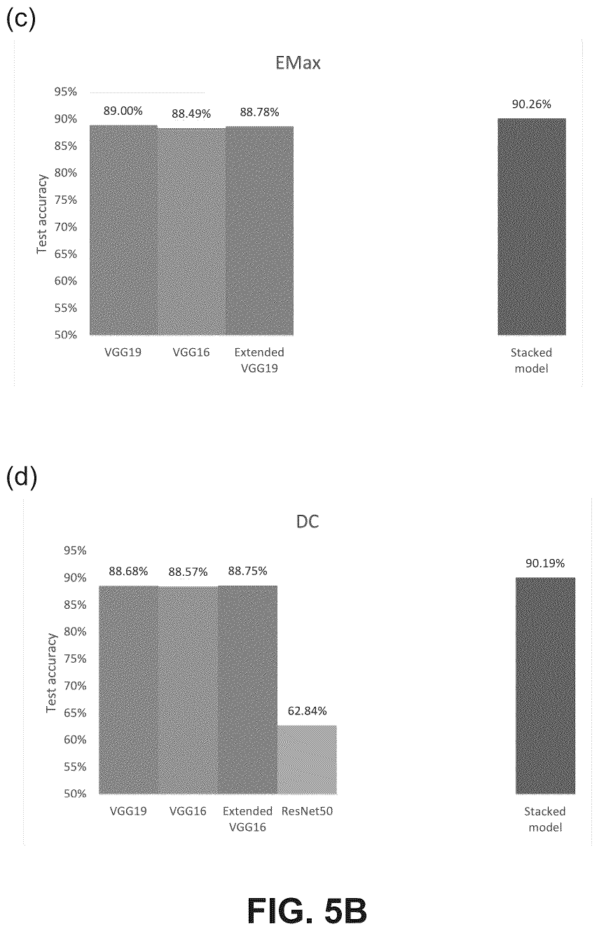

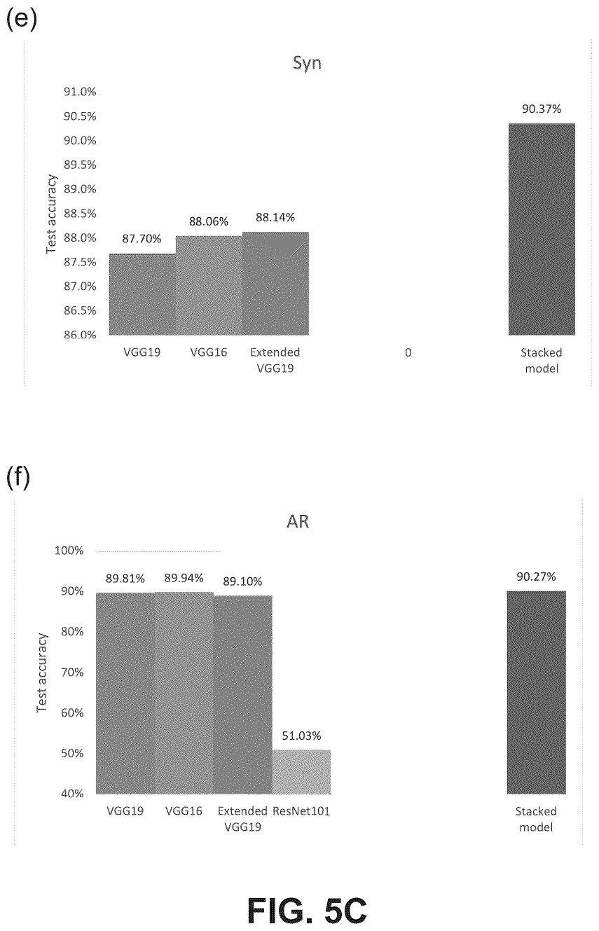

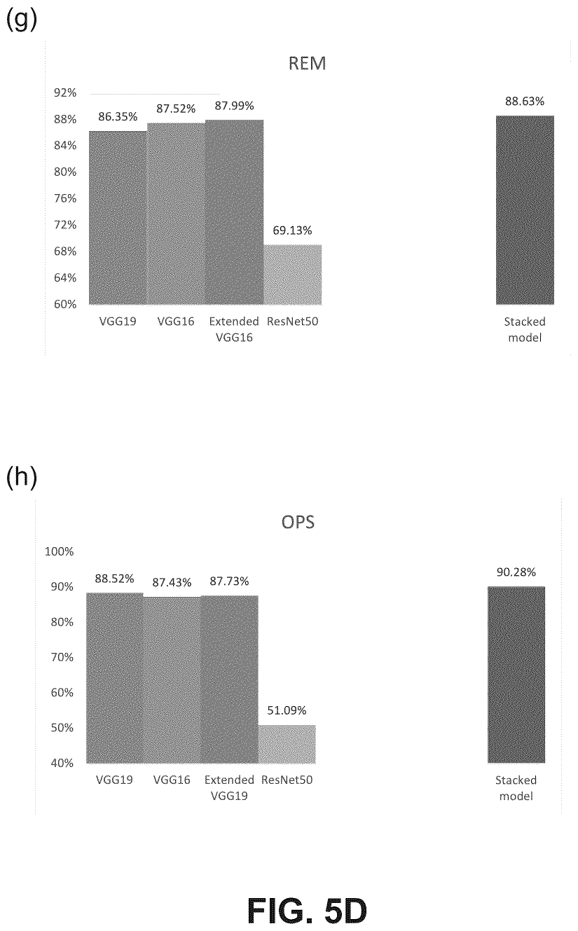

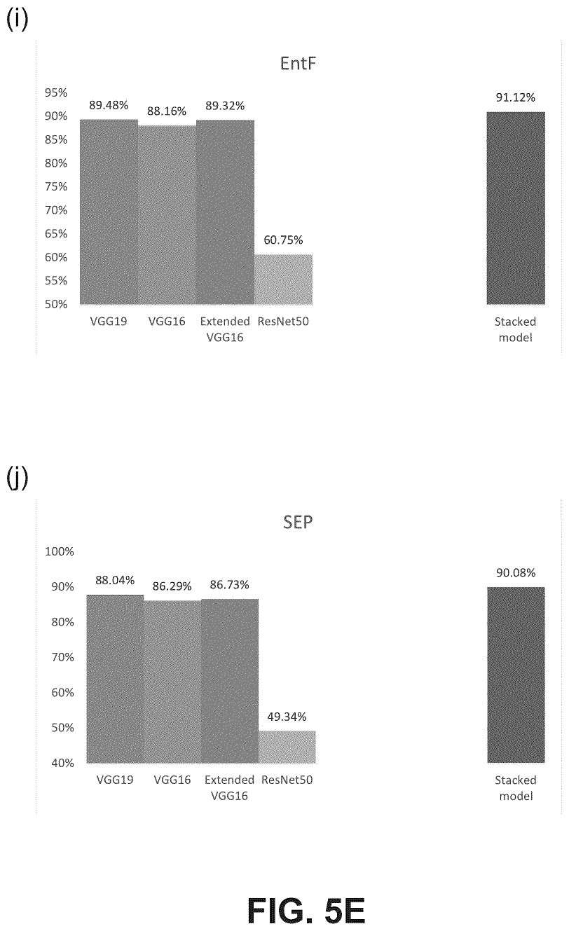

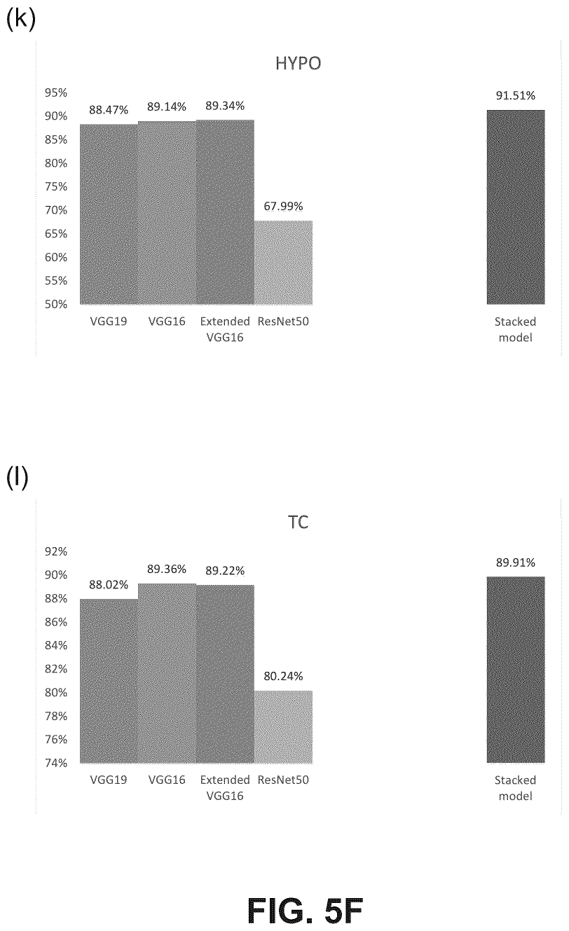

FIGS. 5A-5F are graphs showing experimental results of test accuracy of each DNN model using a stacked ensemble framework in accordance with an example embodiment of the present disclosure.

Graphs (a)-(1) in FIGS. 5A-5F show the test accuracy of each DNN model in the stacking ensemble and the test accuracy of the meta-learner. Graph (a) shows the proposed model ensemble trained on unlearnable CIFAR-10 dataset with NTGA perturbations. The experimental stacking ensemble used VGG19, VGG16, and Extended-VGG19 models, each with individual test accuracies of 87.89%, 87.56%, and 88.53%, respectively. After combining the predictions using the logistic regression model, the enhanced stacked model achieved a test accuracy of 90.37%. Based on graphs (b)-(1), it is noticeable that the ResNet models exhibited lower accuracy compared to the VGG models. This discrepancy may arise because most unlearnable approaches used the ResNet architecture as a surrogate model when crafting perturbations. However, incorporating ResNet models can potentially improve the performance of the logistic regression model because it increases the number of feature variables, thereby increasing the amount of information incorporated into the model.

### Experiments Using the Boosting Ensemble

In an example boosting ensemble framework, the first step is to augment the unlearnable training set. In experiments, the inventors used almost identical experimental settings for all unlearnable datasets. The nonlinear transformation techniques employed in this step included erode, grayscale, and pixel manipulation. While the inventors applied two transformation techniques for the NTGA, EMax, AR, REM, OPS, HYPO, and TC approaches and expanded their dataset sizes to twice the original size, the inventors only applied grayscale transformation for other approaches in the experiments. Moreover, the inventors modified the training and validation set's rotation range, width shift, height shift, shear intensity, and zoom range using the Keras ImageDataGenerator function in training. As for the model, the inventors chose VGG19 pre-trained on ImageNet, followed by an additional convolutional layer with ten neurons and a Softmax activation function corresponding to the ten target classes. To avoid overfitting, the inventors limited the training of the models to up to 30 epochs.

After making predictions on the training set using the trained model, the inventors augmented the misclassified images incorporating nonlinear transformations. In this case, the inventors used the same techniques as in the first step, including dilate. The weights assigned between correctly classified and misclassified images were set to 1:5 for the DC, EMin, Syn, EntF, and SEP approaches. Hence, the misclassified images appeared five times more often than the others in the training set in the experiment. For the other approaches, except AR, the weights between correctly classified and mis-classified images were set to 2:5 because the training set was expanded twice in the first step. Pixel manipulation and erode were applied to misclassified AR images, resulting in a 2:4 weight ratio between misclassified and correctly classified images.

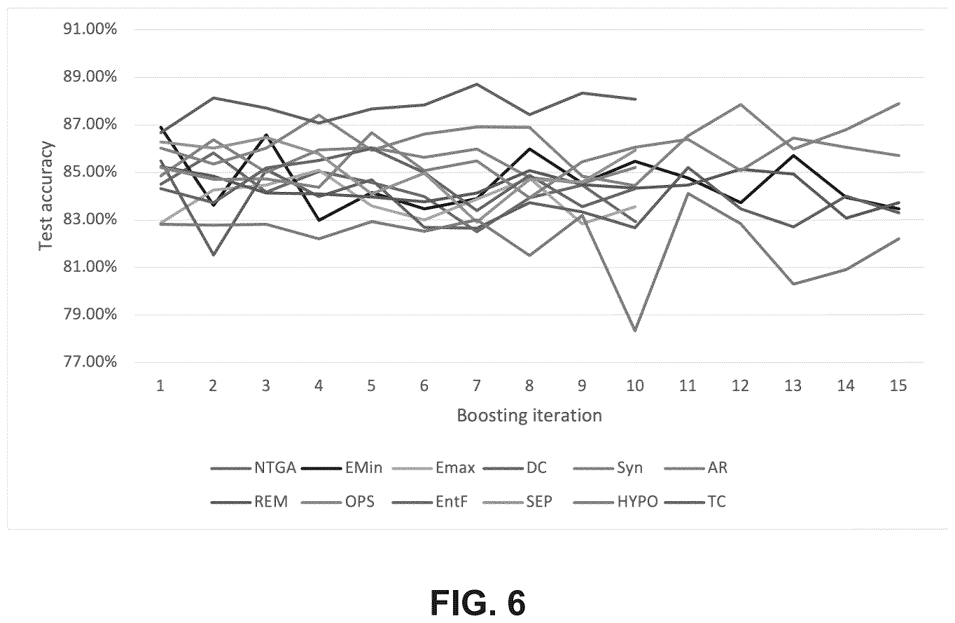

FIG. 6 is a graph of the test accuracies of each model over boosting iterations in experimental results.

The inventors repeated the prediction-augmentation process ten or fifteen times, depending on the test accuracy of the ensemble. The inventors chose fifteen iterations if the final test accuracy was less than 89% after ten trials. The final test accuracy was determined by voting among the resulting ten or fifteen models. FIG. 6 displays the test accuracies of each model over the iterations in experimental results. An increasing or decreasing pattern was not apparent in the test accuracies over the iterations. Therefore, the inventors focused on the final test accuracy of the ensemble to determine the number of iterations. The final test accuracies of the ensemble classifier are shown in the last column of Table 2 below. The inventors repeated each experiment five times and recorded the mean and standard deviation for more consistency. Examining the lines in FIG. 6, it can be seen that the majority of the individual models had a test accuracy below 85% in the experiments. However, the final model ensembles demonstrated an average test accuracy over 87% (see Table 2), indicating the improvement achieved by the ensemble approach. Table 2 shows the test accuracy of the boosting ensemble trained on each unlearnable CIFAR-10 dataset in experiments. The second column (k) presents how many times the augmentation-prediction process was repeated, while weights indicates the frequency of misclassified images compared to others in the training set.

TABLE 2

| Unlearnable dataset | Iterations (k) | Weights | Test accuracy (%) |
|---|---|---|---|
| NTGA | 10 | 2:5 | 89.23 ± 0.19 |
| EMin | 15 | 1:5 | 89.80 ± 0.27 |
| EMax | 10 | 2:5 | 89.04 ± 0.16 |
| DC | 15 | 1:5 | 89.21 ± 0.52 |
| Syn | 10 | 1:5 | 90.05 ± 0.19 |
| AR | 15 | 2:4 | 89.28 ± 0.23 |
| REM | 15 | 2:5 | 87.77 ± 0.19 |
| OPS | 15 | 2:5 | 88.60 ± 0.25 |
| EntF | 10 | 1:5 | 90.14 ± 0.20 |
| SEP | 10 | 1:5 | 90.20 ± 0.20 |
| HYPO | 15 | 2:5 | 87.86 ± 0.15 |
| TC | 10 | 2:5 | 91.04 ± 0.22 |

### Experiments Using the Bagging Ensemble

The first step in building a bagging ensemble is to split the dataset into subsets. In the experiments, the inventors split the unlearnable training set into five subsets to demonstrate the applicability of the proposed bagging framework. The unlearnable CIFAR-10 dataset created by NTGA includes 40,000 training images. When the dataset is divided without overlap, each subset contains 8,000 images. In this case, the test accuracy of the built ensemble was lower than 85% for the NTGA dataset, as shown in the first row of Table 3 below. This may be due to the smaller number of unique images in each subset. Therefore, the inventors decided to use overlapping subsets, resulting in larger datasets. The inventors first selected a class-balanced portion of the training set and shared it with all the five subsets. The overlap percentage was then defined as the size of the shared portion divided by the total training set size. The remaining training data were evenly split among the five subsets, while it was also ensured that each subset receives a class-balanced dataset. Table 3 shows experimental test accuracy of example bagging ensembles using different overlap percentages.

TABLE 3

| | | |
|---|---|---|
| Overlap amount | Test accuracy | Difference |

| | | | |
|---|---|---|---|
| 0 | (0%) | 84.35% | — |
| 5000 | (13%) | 85.61% | 0.0126 |
| 10000 | (25%) | 87.05% | 0.0144 |
| 15000 | (38%) | 86.96% | −0.0009 |
| 20000 | (50%) | 87.66% | 0.007 |
| 25000 | (63%) | 88.98% | 0.0132 |
| 30000 | (75%) | 89.17% | 0.0019 |
| 35000 | (88%) | 89.45% | 0.0028 |
| 40000 | (100%) | 89.4% | −0.0005 |

The test accuracies based on different overlap percentages are presented in Table 3. The size of the overlapping dataset was gradually increased to 5,000, 10,000, and so on. The inventors randomly selected 5,000 images, which was 13% of the total dataset, and included them in all subsets. The remaining 35,000 images were randomly divided into five non-overlapping subsets, to ensure an equal distribution of data from each class across all the subsets. The last column of Table 3, labeled ‘Difference’, gives the accuracy improvement based on the percentages of the data overlap given in the previous row.

When 5,000 images are shared, the accuracy improvement over no overlap was 0.0126. The threshold of 89% was reached when a 75% data overlap was used. However, a significant improvement was observed when a 63% overlap was used. As such, the inventors chose 75% and 63% as the percentages of the data overlap, respectively, for other unlearnable datasets.

The experimental settings used under each unlearnable dataset were almost identical, except that the inventors used slightly different nonlinear transformation techniques for each one. The inventors augmented each subset several times using the same nonlinear transformation techniques, pixel manipulation, erode, dilate, and grayscale. The inventors used the pretrained VGG19 model on ImageNet, as the found that was the best option based on their experiments. The inventors supplemented the pretrained model with an additional fully connected layer containing ten neurons corresponding to each output class, employing the Softmax activation function. Each model was trained for 30 epochs of training to control over-fitting and the execution time. The average test accuracy of the bagging ensemble trained on each unlearnable dataset is shown in Table 4 below. The average and standard deviation are calculated using five trials. All the datasets obtained more than 89% average test accuracy on the proposed bagging ensemble with 75% overlap. Based on these results, it is shown that the proposed bagging ensemble framework can overcome the unlearnability in the twelve obfuscation approaches. Table 4 shows the average test accuracy of the proposed bagging ensembles trained on unlearnable CIFAR-10 datasets.

TABLE 4

Test accuracy

| Unlearnable dataset | 63% overlap | 75% overlap |
|---|---|---|
| NTGA | 88.32 ± 0.48% | 89.03 ± 0.18% |
| EMin | 90.38 ± 0.34% | 90.84 ± 0.29% |
| EMax | 90.31 ± 0.25% | 90.69 ± 0.18% |
| DC | 89.67 ± 0.39% | 90.04 ± 0.36% |
| Syn | 91.13 ± 0.25% | 91.51 ± 0.21% |
| AR | 91.49 ± 0.18% | 91.6 ± 0.36% |
| REM | 88.4 ± 0.42% | 89.15 ± 0.18% |
| OPS | 90.16 ± 0.27% | 90.38 ± 0.16% |
| EntF | 89.62 ± 0.29% | 90.12 ± 0.11% |
| SEP | 89.14 ± 0.18% | 89.66 ± 0.30% |
| HYPO | 89.92 ± 0.2% | 89.93 ± 0.22% |
| TC | 90.02 ± 0.05% | 90.85 ± 0.06% |

### Comparison with Existing Attack Methods

In experiments, the inventors compared the highest test accuracy achieved by using the three proposed frameworks with those obtained from other existing attack methods, including CutMix, Mixup, adversarial training, and nonlinear transformations. To make a fair comparison, the inventors used the VGG19 model architecture across all the three frameworks. In CutMix, the inventors randomly selected a region of the image and replaced it with a corresponding region from another image, with the labels mixed proportionally to the area of the cutout. In Mixup, the inventors combined two images by performing a linear combination of their pixel values. The inventors used random values drawn from a Beta distribution as the weights for the linear combination. The inventors also merged the labels of the two images together using the same linear combination. For adversarial training, the inventors used the Projected Gradient Descent (PGD) noise with a perturbation range of 4/255 and a step size of 0.8/255. Column 6 of Table 5 gives the test accuracies obtained by applying nonlinear transformations. Additionally, in column 2, the inventors reported the test accuracies of VGG19 models trained on unlearnable data without the use of any attack method. Table 5 shows the experimental test accuracy of the unlearnable data generated by twelve (12) obfuscation methods, where VGG19 was used as a base model and the test accuracy of a method according to an example embodiment (“Our method”) was calculated based on the average of the highest test accuracy obtained by the three ensemble learning frameworks.

TABLE 5

| | | | | Adver- | Nonlinear | |
|---|---|---|---|---|---|---|
| | No | | | sarial | transfor- | Our |
| Unlearnable | attack | CutMix | Mixup | training | mations | method |
| dataset | (%) | (%) | (%) | (%) | (%) | (%) |
| NTGA | 36.57 | 40.97 | 40.08 | 83.41 | 87.75 | 90.17 |
| EMin | 24.34 | 21.98 | 35.43 | 72.86 | 81.46 | 90.84 |
| Emax | 82.35 | 81.88 | 81.09 | 84.77 | 91.82 | 90.69 |
| DC | 20.61 | 15.64 | 20.27 | 84.45 | 86.74 | 90.30 |
| Syn | 28.68 | 25.86 | 26.11 | 85.32 | 87.37 | 91.51 |
| AR | 49.38 | 32.25 | 66.97 | 79.94 | 86.63 | 91.60 |
| REM | 44.04 | 36.96 | 46.24 | 50.46 | 83.68 | 89.15 |
| OPS | 22.16 | 40.89 | 33.33 | 11.17 | 86.64 | 90.38 |
| EntF | 83.55 | 83.92 | 80.04 | 87.75 | 89.48 | 90.96 |
| SEP | 85.47 | 82.77 | 82.74 | 86.23 | 87.60 | 90.20 |
| HYPO | 35.36 | 40.18 | 38.53 | 64.84 | 88.73 | 91.37 |
| TC | 83.67 | 74.72 | 82.31 | 90.62 | 90.04 | 91.04 |

In Table 5, the inventors provide empirical evidence to show how nonlinear transformations disrupt the effectiveness of unlearnable perturbations with both linear and nonlinear perturbations. Columns 2 and 5 show the test accuracies of the VGG19 model trained without and with nonlinear transformations respectively. The nonlinear transformations used in the experimental case were the same as those discussed above. While the effects of linearly separable perturbations, such as NTGA, EMin, EMax, DC, Syn, and REM, were mitigated, resulting in very high test accuracy, nonlinear perturbations, such as AR, were also defeated by these transformations.

Table 6 below gives the test accuracy improvement of example embodiments in experiments compared to the other four existing attack methods. The experimental method employed according to an example embodiment clearly outperformed CutMix and Mixup.

Compared to adversarial training, a method according to an example embodiment demonstrated a significant improvement (e.g., more than 10%) in the test accuracy for the EMin, AR, REM, OPS, and HYPO datasets, along with a marginal improvement over the others. Furthermore, the inventors' method achieved a marginal improvement over the nonlinear transformations, except for the EMax dataset. The bagging and stacking methods can be easily parallelized to save time and improve efficiency in an example embodiment. Table 6 shows experimental test accuracy improvement of an example embodiment compared to the nonlinear transformations method and three other conventional methods.

TABLE 6

| | No | | | Adversarial | Nonlinear |
|---|---|---|---|---|---|
| Unlearnable | attack | CutMix | Mixup | training | transformations |
| dataset | (%) | (%) | (%) | (%) | (%) |
| NTGA | +53.60 | +49.20 | +50.09 | +6.76 | +2.42 |
| EMin | +66.50 | +68.86 | +55.41 | +17.98 | +9.38 |
| Emax | +8.34 | +8.81 | +9.60 | +5.92 | −1.13 |
| DC | +69.69 | +74.66 | +70.03 | +5.85 | +3.56 |
| Syn | +62.83 | +65.65 | +65.40 | +6.19 | +4.14 |
| AR | +42.22 | +59.35 | +24.63 | +11.66 | +4.97 |
| REM | +45.11 | +52.19 | +42.91 | +38.69 | +5.47 |
| OPS | +68.22 | +49.49 | +57.05 | +79.21 | +3.74 |
| EntF | +7.41 | +7.04 | +10.92 | +8.66 | +3.21 |
| SEP | +4.73 | +7.43 | +7.46 | +3.97 | +2.60 |
| HYPO | +56.01 | +51.19 | +52.84 | +26.53 | +2.64 |
| TC | +7.37 | +16.32 | +8.73 | +0.42 | +0.94 |

### Experimental Settings

The experiments were conducted using the following package versions: Python 3.9.13, TensorFlow 2.4.1, NumPy 1.23.1, OpenCV-Python 4.6.0.66, and Pandas 2.2.3. All ensemble learning frameworks used pretrained models in Keras, such as ResNet and VGG. The optimizer was set to stochastic gradient descent (SGD) with a momentum of 0.9. Categorical cross-entropy was used as the loss function, while accuracy—the proportion of correct predictions—served as the evaluation metric. Learning rates and number of epochs were varied across experiments.

Determining hyperparameters, such as the number of epochs, was very important. In the inventors' experiments, the number of epochs was carefully determined to reduce overfitting and execution time. Furthermore, the training time per model was constrained to ensure efficiency. For the number of epochs in the models, a range of 25 to 35 was considered to limit training time and control execution time. The best accuracy was achieved at 30 epochs, making it the chosen value for the NTGA dataset. Another hyperparameter considered was the learning rate. Based on the experiments, the learning rate was chosen within a range of 0.1 to 0.001. Starting from 0.001, the learning rate was gradually increased until the value yielding the highest test accuracy was identified. The search was stopped once the desired test accuracy was achieved. Similarly, when selecting hyperparameters, both test accuracy improvement and execution time were taken into consideration. When selecting the model architectures, the inventors' search space included the pretrained models listed in Keras Applications. The inventors initially chose the most commonly used models in the literature, such as ResNet and VGG architectures. The inventors then incrementally added different model architectures until the ensemble achieved the desired test accuracy.

Additionally, the number of boosting iterations was chosen systematically. The inventors limited their search in the range from 8 to 20 by considering execution time. For instance, when the number of iterations was increased from 10 to 15, and from 15 to 20, the accuracy improved only slightly, and the gain was very limited. On the other hand, the execution time increased significantly because five additional models were added to the ensemble. Therefore, to save execution time, 10 iterations were chosen. Other parameters, such as the weights in the boosting ensemble, were selected in a similar manner. Moreover, the primary hyperparameter in the bagging ensemble — the overlap percentage — was carefully determined based on the overall test accuracy.

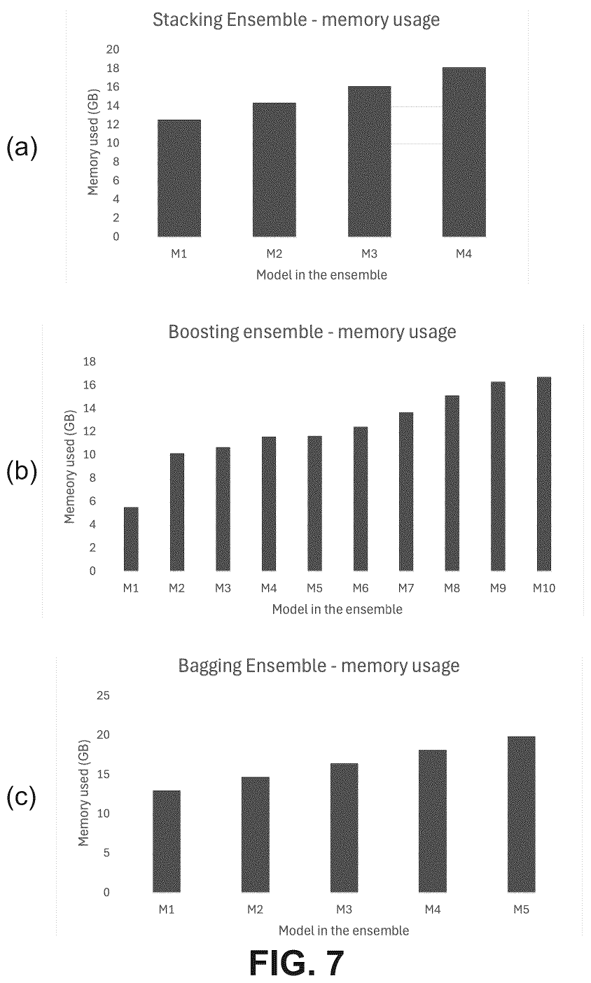

FIG. 7 is a set of graphs showing experimental results of memory usage on each model in the ensembles according to example embodiments.

The inventors used the NVIDIA GeForce GTX 1070 Ti GPU in the University of South Florida research cluster to conduct their experiments. Each experiment was conducted using a single GPU. The training time of the example ensemble learning methods primarily depended on the number of models in the ensemble and how many times the dataset was expanded. Otherwise, the training time remained constant across the twelve datasets. To provide a general understanding of the training time for each approach, the training and testing times for experiments related to the EMin dataset are shown in Table 7. For other datasets, the training time varied slightly, depending on the number of models in the ensemble and how many times the dataset was expanded. In general, the boosting approach took the longest time due to the larger number of models in the ensemble. FIG. 7 shows the memory usage for each model, with graph (a) being for stacking, graph (b) being for boosting, and graph (c) being for bagging. The memory usage was gradually increased with the number of models in each ensemble, with the maximum memory usage reaching approximately 20 GB. Table 7 shows training and testing time of the ensembles in experiments.

TABLE 7

| Framework | Training time | Testing time |
|---|---|---|
| Stacking | 2 hours and 15 minutes | 13 seconds |
| Boosting | 3 hours and 57 minutes | 51 seconds |
| Bagging | 2 hours and 42 minutes | 25 seconds |

### Additional Discussion

In their research, the inventors demonstrated that they can successfully improve existing ensemble learning frameworks to mitigate the effects of unlearnable perturbations. The inventors used the proposed frameworks to show that unlearnable data are vulnerable to such advanced machine learning techniques and require further improvement.

Overall, the inventors' results show that the proposed ensemble learning frameworks can be effectively implemented on unlearnable data by overcoming the challenges associated with it. The first challenge was to ensure that the base models in the ensembles were sufficiently diverse to contribute unique insights while maintaining individual accuracy. The performance of diverse models on unlearnable data varied significantly due to the effects of added perturbations. Therefore, selecting diverse models with strong individual performance on unlearnable data posed a serious trade-off compared to traditional ensemble learning on clean data. As a result, the inventors had to rely on similar model architectures, primarily VGG, to ensure reasonable performance. The second challenge arose from the difficulty of addressing the first: using highly correlated base models reduces the benefit of the ensemble and yields only marginal improvements. Adjusting the nonlinear transformation based on the model architecture may be a good approach to address this issue. The third challenge is the extensive computational cost, as ensemble learning requires training multiple models and aggregating their predictions. When applied to unlearnable data, this challenge is amplified due to the need for more iterations to achieve convergence, especially when using extensive data augmentation techniques. To manage time and computational cost, the inventors limited the number of training epochs per each model. Overcoming these challenges requires careful design, experimentation, and domain expertise in order to adapt the ensemble methodology to specific use cases.

In the experimental example stacking method, the inventors used a logistic model with the liblinear solver as the meta-learner. The inventors also noticed that the meta-learner did not significantly improve the performance compared to the individual models in the cases of EMax and EMin. In addition, the ResNet architecture did not perform well against most of the unlearnable datasets. Most studies use a ResNet architecture as a base model when developing unlearnable perturbations. Hence, ResNet architectures are more likely to be vulnerable to unlearnable datasets than the other architectures. In the inventors' experiment, ResNet18 was used as the base model to generate EMin, EMax, REM, EntF, SEP, and TC perturbations, as it is the default architecture in their respective codes. The experimental results in FIGS. 5A-5F imply that the ResNet models have lower accuracy compared to VGG. However, in those experiments, some hyperparameters, such as the number of epochs and the learning rate, were not the same for each of the models. Therefore, the lower accuracy may not necessarily be due to the difference in the model architectures. The inventors conducted additional experiments to explicitly compare the impact of model architectures, where they used VGG19 and ResNet50, respectively. In these experiments, the inventors kept all other parameters the same, except for the model architecture. These experimental results are displayed in Table 8 below. There was a significant reduction in accuracy for ResNet50 in comparison to VGG19. However, the inventors did not evaluate other datasets because they did not use ResNet18 as a base model. For instance, the DC and NTGA datasets were generated using an 8-layer U-Net and a 3-layer convolutional network, respectively. The HYPO dataset was generated utilizing VGG16, following the default settings in its code. Furthermore, Syn, AR, and OPS perturbations are model-free attacks that do not involve surrogate models. The inventors observed a significant reduction in accuracy for ResNet50 compared to VGG19, even with nonlinear transformations. Additionally, in the experiments, the DC dataset utilized an 8-layer U-Net as the model architecture, while NTGA used a 3-layer convolutional network to generate perturbations. The inventors also used VGG16 as the surrogate model for HYPO, adhering to its default setting. Furthermore, Syn, AR, and OPS perturbations are model-free attacks that do not involve surrogate models. However, the outputs of the ResNet model helped the inventors to improve the performance of the meta-learner by adding predictor variables to the logistic regression model. Table 8 shows the effect of model architecture for defeating unlearnable data created by ResNet18 in experiments.

TABLE 8

| Model | EMin | EMax | REM | EntF | SEP | TC |
|---|---|---|---|---|---|---|
| VGG19 | 81.46% | 91.82% | 83.68% | 87.75% | 87.60% | 90.10% |
| ResNet50 | 74.52% | 82.02% | 75.91% | 78.38% | 83.67% | 84.29% |

For the bagging and boosting ensembles used in the experiments, the inventors chose VGG as their base model. While they experimented with various base models, including ResNet, they ultimately selected VGG due to its superior performance. This was further validated by the stacking ensembles, which demonstrated better results with VGG compared to other models. The inventors conducted the three ensemble learning frameworks, e.g., stacking, boosting, and bagging, independently. In the future, any combination and/or all three frameworks may be combined create a single approach, which may be more robust against unlearnable data.

In the example bagging method, the dataset may be split with a large overlap to achieve better performance. The bagging approach according to example embodiments is different from the conventional bagging method, which aims to reduce the variance within the dataset by splitting it into distinct non-overlapping subsets. In the experiments with unlearnable CIFAR-10 datasets, the inventors observed better results with larger datasets, which led them to choose subsets with large overlap. In addition, the inventors only considered five subsets in the experiments of the bagging method, but the performance of the example bagging ensemble may vary when the number of subsets varies.

To apply our method to the MNIST and ImageNet datasets, the inventors followed the same frameworks with different hyperparameters such as model architectures, nonlinear transformations, a number of epochs, and a batch size. Table 9 below shows their experimental results. The stacking ensemble did not improve accuracy over the nonlinear transformation approach. However, the boosting and bagging ensembles achieved slightly better test accuracy than the nonlinear transformation approach. A challenge in applying the example method to different datasets lies in determining model architectures, nonlinear transformations, and other hyperparameters. The hyperparameters may be highly dependent on the dataset, but the overall framework may remain the same. Table 9 shows the test accuracy of the unlearnable MNIST and ImageNet datasets generated by NTGA in experiments.

TABLE 9

| | No | Nonlinear | | | |
|---|---|---|---|---|---|
| Unlearnable | attack | transformations | Stacking | Boosting | Bagging |
| dataset | (%) | (%) | (%) | (%) | (%) |
| MNIST | 22.83 | 98.87 | 98.82 | 99.02 | 99.13 |
| ImageNet | 74.47 | 91.43 | 91.43 | 94.28 | 92.85 |

The experiments were primarily conduced on CIFAR-10, but the inventors further evaluated the example frameworks on unlearnable CIFAR-100 datasets generated by three data protection approaches: EMin, Syn, and OPS. The inventors used these three approaches to demonstrate the generalizability of the proposed frameworks. First, the inventors trained a single pretrained VGG16 model on the clean and unlearnable CIFAR-100 datasets to assess the performance of the datasets. The model trained on the clean CIFAR-100 achieved a test accuracy of 61.38%, while the models trained on the EMin, Syn, and OPS datasets resulted in test accuracies of 26.36%, 28.67%, and 45.91%, respectively. The inventors then applied our ensemble learning frameworks to the unlearnable datasets. Table 10 below presents experimental results of the stacking ensemble implemented on unlearnable CIFAR-100 datasets. The inventors achieved a test accuracy comparable to the model trained on the clean dataset. Table 11 below shows experimental results obtained after applying the boosting ensemble framework to unlearnable CIFAR-100 datasets. The inventors chose VGG16 as the model architecture since it achieved the highest accuracies in the stacking ensemble. Table 12 below provides the test accuracies obtained by applying the bagging ensemble to unlearnable CIFAR-100 datasets in experiments. The inventors observed a significant reduction in accuracy compared to the stacking and boosting ensembles. This may be due to the fact that the CIFAR-100 dataset contains a limited number of images (4,000) for each class. When these images were divided across five subsets, each subset received only a small number of images per class.

In the example frameworks, several innovative steps are introduced to reduce the impact of unlearnable datasets when applying ensemble learning to them. In the boosting method, the weights of misclassified images may be increased by repeating them and applying nonlinear transformations on them. In the stacking method, different DNN architectures may be utilized to incorporate the diversity of base models needed for ensemble learning. In the bagging method, overlapping subsets may be introduced to reduce the bias in the data, and to mitigate the overfitting caused by unlearnable data. The experiments demonstrate that example embodiments outperform four prominent attack techniques across eleven unlearnable datasets.

TABLE 10

| | | | Nonlinear | |
|---|---|---|---|---|
| | No attack | Models in | transformations | Test |
| Dataset | (VGG16) | the ensemble | used | accuracy |
| Clean | 61.38% | — | — | — |
| EMin | 26.39% | VGG19/VGG16/ | Pixel manipulation | 61.31% |
| | | ExtendedVGG19/ | (twice) and | |
| | | ResNet101 | grayscale | |
| Syn | 28.67% | VGG19/VGG16/ | Pixel manipulation | 61.60% |
| | | ExtendedVGG19/ | (twice) and | |
| | | ResNet101 | grayscale | |
| OPS | 45.91% | VGG19/VGG16/ | pixel manipulation, | 61.21% |
| | | ExtendedVGG19 | grayscale, dilate | |
| | | | and erode | |

TABLE 11

| | | | Nonlinear transformations used on: | | |
|---|---|---|---|---|---|
| | Itera- | | Full | Misclassified | Test |
| Dataset | tions | Weights | dataset | data | accuracy |
| EMin | 10 | 1:5 | grayscale | pixel manipulation | 60.81% |
| | | | | (thrice) and erode | |
| Syn | 10 | 1:5 | grayscale | pixel manipulation | 62.58% |
| | | | | (thrice) and erode | |
| OPS | 10 | 2:5 | erode | pixel manipulation | 60.14% |
| | | | | (twice) and dilate | |

TABLE 12

| | | Test accuracy |
|---|---|---|
| Dataset | Nonlinear transformations used | (75% overlap) |
| EMin | Pixel manipulation (thrice) and grayscale | 56.31% |
| Syn | Pixel manipulation (thrice), grayscale, and | 56.48% |
| | erode | |
| OPS | Pixel manipulation (twice), grayscale, erode, | 60.76% |
| | and dilate | |

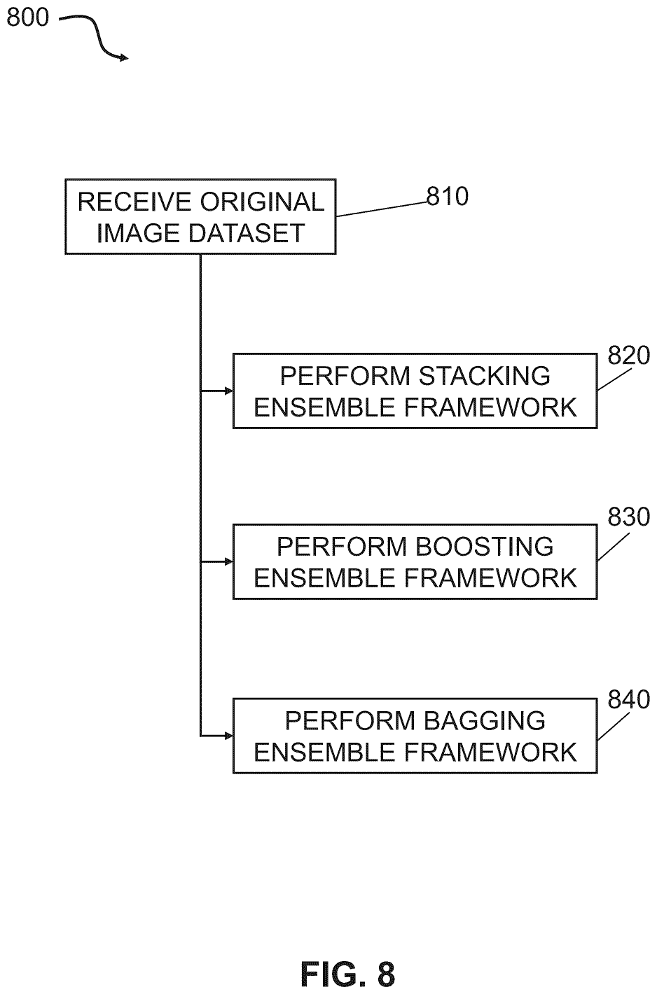

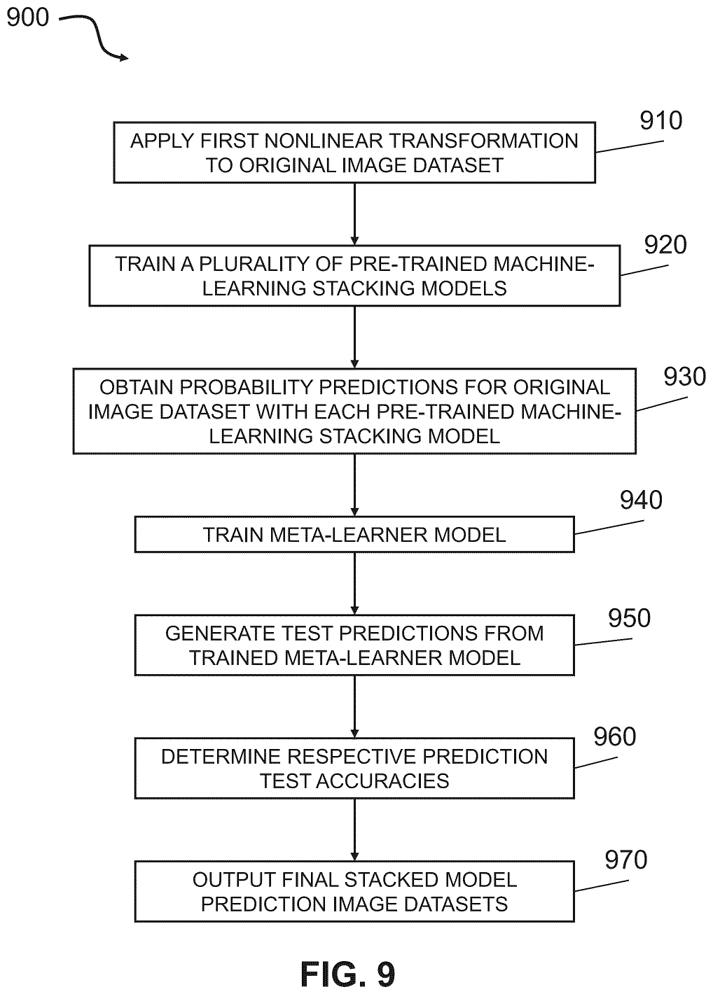

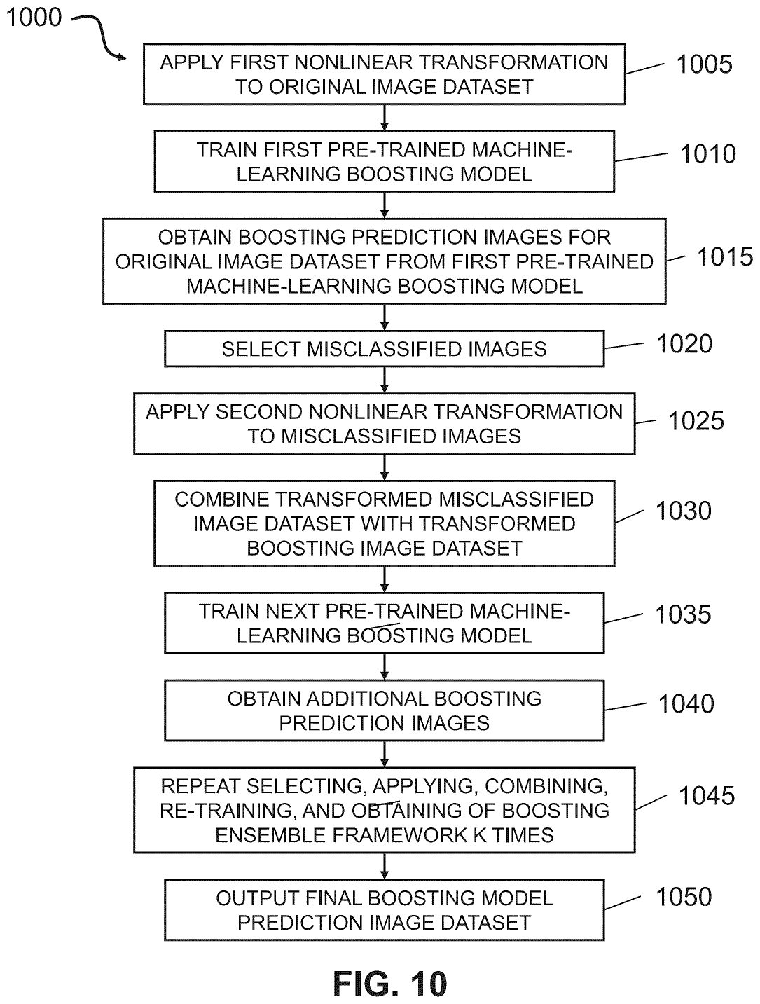

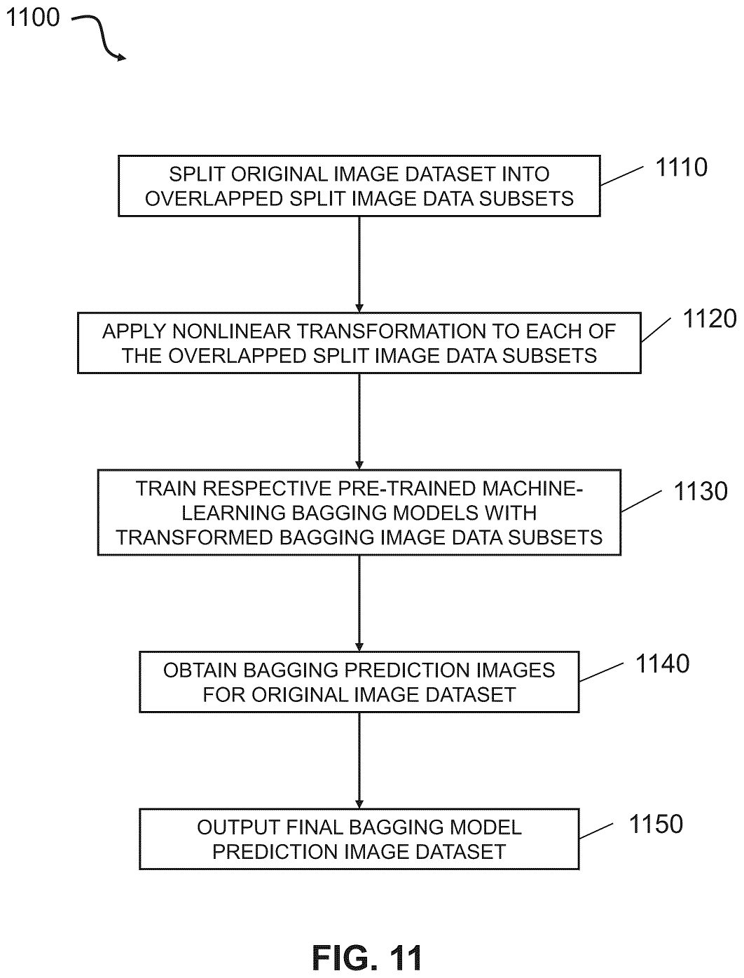

FIG. 8 is a flowchart of an example method for training a machine-learning model to break obfuscated image data. FIG. 9 is a flowchart of an example method for training a machine-learning model to break obfuscated image data. FIG. 10 is a flowchart of an example method for training a machine-learning model to break obfuscated image data. FIG. 11 is a flowchart of an example method for training a machine-learning model to break obfuscated image data.

With reference to FIG. 8, an example method 800 may include, at 810, receiving an original image dataset comprising image data that is obfuscated to machine learning. The method 800 may further include performing an ensemble machine-learning training framework, which may include at least one of: a stacking ensemble framework 820, a boosting ensemble framework 830, a bagging ensemble framework 840.

FIG. 9 shows an example stacking ensemble framework 900, e.g., the stacking ensemble framework 820 of FIG. 8. The example stacking ensemble framework 900 may include, at block 910, comprising: applying a first nonlinear transformation to the original image dataset to generate a transformed stacking image dataset. The example stacking ensemble framework 900 may further include, at block 920, training a plurality of pre-trained machine-learning stacking models with the transformed stacking image dataset. The example stacking ensemble framework 900 may further include, at block 930, obtaining probability predictions for the original image dataset with each of the plurality of pre-trained machine-learning stacking models. The example stacking ensemble framework 900 may further include, at block 940, training a meta-learner model with the obtained probability predictions as an independent variable and with the original image dataset as a target variable. The example stacking ensemble framework 900 may further include, at block 950, generating test predictions from the trained meta-learner model with the transformed image dataset. The example stacking ensemble framework 900 may further include, at block 960, determining a respective prediction test accuracy for each of the test predictions. The example stacking ensemble framework 900 may further include, at block 970, for each of the plurality of pre-trained machine-learning models, in response to the prediction test accuracy being greater than a target test accuracy, outputting a corresponding final stacked model prediction image dataset.

FIG. 10 shows an example boosting ensemble framework 1000, e.g., the boosting ensemble framework 830 of FIG. 8. The example boosting ensemble framework 1000 may include, at block 1005, applying a first nonlinear transformation to the original image dataset to generate a transformed boosting image dataset. The example boosting ensemble framework 1000 may further include, at block 1010, training a first pre-trained machine-learning boosting model with the transformed boosting image dataset. The example boosting ensemble framework 1000 may further include, at block 1015, obtaining boosting prediction images for the original image dataset from the first pre-trained machine-learning boosting model with the transformed boosting image dataset.

The example boosting ensemble framework 1000 may further include, at block 1020, selecting misclassified images from among the boosting prediction images. The example boosting ensemble framework 1000 may further include, at block 1025, applying a second nonlinear transformation to the misclassified images to generate a transformed misclassified image dataset, the second nonlinear transformation being a different type from the first nonlinear transformation. The example boosting ensemble framework 1000 may further include, at block 1030, combining the transformed misclassified image dataset with the transformed boosting image dataset to generate a boosted image dataset. The example boosting ensemble framework 1000 may further include, at block 1035, training a next pre-trained machine-learning boosting model with the boosted image dataset. The example boosting ensemble framework 1000 may further include, at block 1040, obtaining additional boosting prediction images for the original image dataset from the pre-trained machine-learning boosting model with the boosted image dataset. The example boosting ensemble framework 1000 may further include, at block 1045, repeating the selecting, applying, combining, re-training, and obtaining of the boosting ensemble framework k times, such that k pre-trained machine-learning boosting models are trained and k sets of boosting prediction images are obtained, where k is an integer greater than two, each subsequent iteration of misclassified images being assigned a greater weight than a preceding iteration of misclassified images. The example boosting ensemble framework 1000 may further include, at block 1050, outputting a final boosting prediction image dataset from among the k sets of boosting prediction images by majority voting based on respective test accuracies for each of the k pre-trained machine-learning boosting models.

FIG. 11 shows an example bagging ensemble framework 1100, e.g., the bagging ensemble framework 840 of FIG. 8. The example bagging ensemble framework 1100 may include, at block 1110, splitting the original image dataset into a plurality of overlapped split image data subsets.

The example stacking ensemble framework 1100 may further include, at block 1120, applying at least one of a plurality of nonlinear transformations to each of the overlapped split image data subsets to generate corresponding transformed bagging image data subsets. The example stacking ensemble framework 1100 may further include, at block 1130, training a respective pre-trained machine-learning bagging model with each of the transformed bagging image data subsets. The example stacking ensemble framework 1100 may further include, at block 1140, obtaining bagging prediction images for the original image dataset from each of the pre-trained machine-learning bagging models with the transformed bagging image data subsets. The example stacking ensemble framework 1100 may further include, at block 1150, outputting a final bagging model prediction image dataset by combining the bagging prediction images by majority voting based on respective test accuracies for each of the pre-trained machine-learning bagging models.

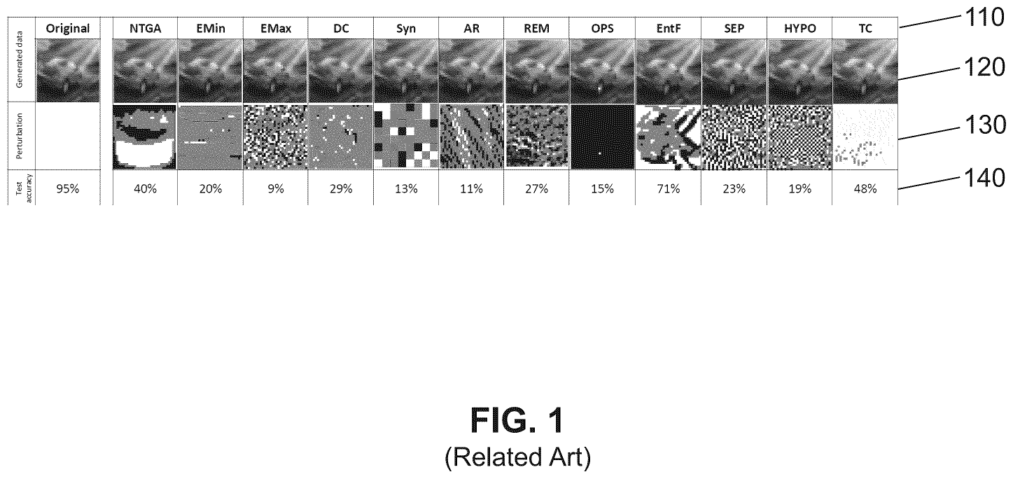

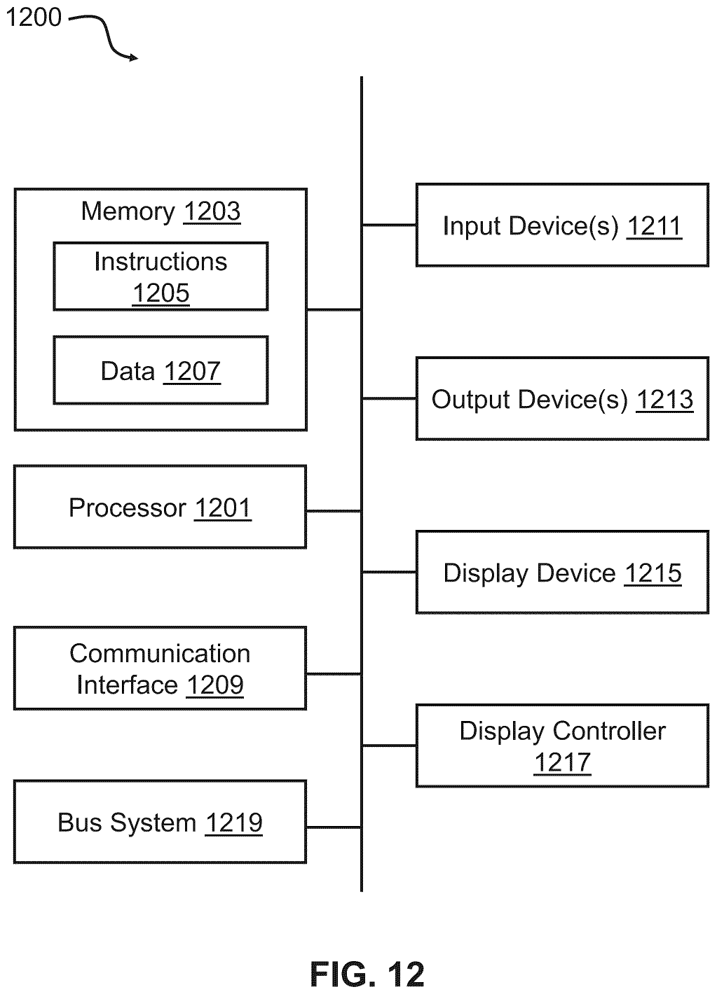

FIG. 12 illustrates certain components that may be included within a computer system 1200, which may be used to control features according to embodiments of the present disclosure, such as the features discussed with reference to FIGS. 1-11. One or more computer systems 1200 may be used to implement the various devices, components, and systems described herein.

The computer system 1200 includes a processor 1201. The processor 1201 may be a single processor or may include multiple processors and/or sub-processors. The processor 1201 may be a general-purpose single- or multi-chip microprocessor (e.g., an Advanced RISC (Reduced Instruction Set Computer) Machine (ARM)), a special-purpose microprocessor (e.g., a digital signal processor (DSP)), a microcontroller, a programmable gate array, etc. The processor 1201 may be referred to as a central processing unit (CPU). Although just a single processor 1201 is shown in the computer system 1200 of FIG. 12, in an alternative configuration, a combination of processors (e.g., an ARM and DSP) could be used. In one or more embodiments, the computer system 1200 further includes one or more graphics processing units (GPUs), which can provide processing services related to both entity classification and graph generation.

The computer system 1200 also includes memory 1203 in electronic communication with the processor 1201. The memory 1203 may be any electronic component capable of storing electronic information. For example, the memory 1203 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, at least one non-transitory computer-readable and/or processor-readable medium, and so forth, including combinations thereof. The memory may include a single memory devices or multiple memory devices.

Instructions 1205 and data 1207 may be stored in the memory 1203. The instructions 1205 may be executable by the processor 1201 to implement some or all of the functionality disclosed herein. Executing the instructions 1205 may involve the use of the data 1207 that is stored in the memory 1203. Any of the various examples of modules and components described herein may be implemented, partially or wholly, as instructions 1205 stored in memory 1203 and executed by the processor 1201. Any of the various examples of data described herein may be among the data 1207 that is stored in memory 1203 and used during execution of the instructions 1205 by the processor 1201.

A computer system 1200 may also include one or more communication interfaces 1209 for communicating with other electronic devices. The communication interface(s) 1209 may be based on wired communication technology, wireless communication technology, or both. Some examples of communication interfaces 1209 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 1200 may also include one or more input devices 1211 and one or more output devices 1213. Some examples of input devices 1211 include a keyboard, mouse, microphone, remote control device, button, joystick, trackball, touchpad, and lightpen. Some examples of output devices 1213 include a speaker and a printer. One specific type of output device that is typically included in a computer system 1200 is a display device 1215. Display devices 1215 used with embodiments disclosed herein may utilize any suitable image projection technology, such as liquid crystal display (LCD), light-emitting diode (LED), gas plasma, electroluminescence, or the like. A display controller 1217 may also be provided, for converting data 1207 stored in the memory 1203 into text, graphics, and/or moving images (as appropriate) shown on the display device 1215.

The various components of the computer system 1200 may be coupled together by one or more buses, which may include a power bus, a control signal bus, a status signal bus, a data bus, etc. For the sake of clarity, the various buses are illustrated in FIG. 12 as a bus system 1219.

The following are sections in accordance with at least one embodiment of the present disclosure:
Clause 1: A method for training a machine-learning model to break obfuscated image data, the method including: receiving an original image dataset including image data that is obfuscated to machine learning, and performing an ensemble machine-learning training framework including at least one of: a stacking ensemble framework including: applying a first nonlinear transformation to the original image dataset to generate a transformed stacking image dataset, training a plurality of pre-trained machine-learning stacking models with the transformed stacking image dataset, obtaining probability predictions for the original image dataset with each of the plurality of pre-trained machine-learning stacking models, training a meta-learner model with the obtained probability predictions as an independent variable and with the original image dataset as a target variable, generating test predictions from the trained meta-learner model with the transformed image dataset, determining a respective prediction test accuracy for each of the test predictions, and for each of the plurality of pre-trained machine-learning models, in response to the prediction test accuracy being greater than a target test accuracy, outputting a corresponding final stacked model prediction image dataset, a boosting ensemble framework including: applying a first nonlinear transformation to the original image dataset to generate a transformed boosting image dataset, training a first pre-trained machine-learning boosting model with the transformed boosting image dataset, obtaining boosting prediction images for the original image dataset from the first pre-trained machine-learning boosting model with the transformed boosting image dataset, selecting misclassified images from among the boosting prediction images, applying a second nonlinear transformation to the misclassified images to generate a transformed misclassified image dataset, the second nonlinear transformation being a different type from the first nonlinear transformation, combining the transformed misclassified image dataset with the transformed boosting image dataset to generate a boosted image dataset, training a next pre-trained machine-learning boosting model with the boosted image dataset, obtaining additional boosting prediction images for the original image dataset from the pre-trained machine-learning boosting model with the boosted image dataset, repeating the selecting, applying, combining, re-training, and obtaining of the boosting ensemble framework k times, such that k pre-trained machine-learning boosting models are trained and k sets of boosting prediction images are obtained, where k is an integer greater than two, each subsequent iteration of misclassified images being assigned a greater weight than a preceding iteration of misclassified images, and outputting a final boosting prediction image dataset from among the k sets of boosting prediction images by majority voting based on respective test accuracies for each of the k pre-trained machine-learning boosting models, or a bagging ensemble framework including: splitting the original image dataset into a plurality of overlapped split image data subsets, applying at least one of a plurality of nonlinear transformations to each of the overlapped split image data subsets to generate corresponding transformed bagging image data subsets, training a respective pre-trained machine-learning bagging model with each of the transformed bagging image data subsets, obtaining bagging prediction images for the original image dataset from each of the pre-trained machine-learning bagging models with the transformed bagging image data subsets, and outputting a final bagging model prediction image dataset by combining the bagging prediction images by majority voting based on respective test accuracies for each of the pre-trained machine-learning bagging models.
Clause 2: The method of clause 1, wherein the meta-learner model includes a logistic regression model.
Clause 3: The method of clause 1, further including generating an evaluation of a final model prediction dataset, among any of output final stacked model prediction image dataset, final boosting prediction image dataset, or final bagging model prediction image dataset, the evaluation including a determination of accuracy of the final model prediction dataset.
Clause 4: The method of clause 3, further including generating an evaluation of an accuracy of the performed ensemble machine-learning training framework.
Clause 5: The method of clause 1, wherein each of the first nonlinear transformation, the second nonlinear transformation, and the a plurality of nonlinear transformations includes one or more of: erode, dilate, pixel manipulation, or grayscale.
Clause 6: The method of clause 5, wherein a separate pixel manipulation is applied for each of a plurality of color channels.
Clause 7: The method of clause 1, wherein an overlap percentage of the plurality of overlapped split image data subsets is 63% or 75%.
Clause 8: The method of clause 1, wherein a number of epochs for training each pre-trained machine-learning stacking model, pre-trained machine-learning boosting model, and pre-trained machine-learning bagging model is 25-35.
Clause 9: The method of clause 1, wherein each pre-trained machine-learning stacking model, pre-trained machine-learning boosting model, and pre-trained machine-learning bagging model is a deep neural network (DNN) model.
Clause 10: The method of clause 9, wherein the DNN model includes one of: VGG19, VGG16, ExtendedVGG19, or ResNet50.
Clause 11: The method of clause 1, wherein the original image dataset is obfuscated to machine learning by data protection including one or more of: Neural Tangent Generalization Attacks (NTGA), Error-Minimizing (EMin), Error-Maximizing (EMax), Deep-Confuse (DC), Synthetic (Syn), Auto Regressive (AR), Robust Error-Minimizing (REM), One-Pixel Shortcut (OPS), Entangled-Features (EntF), Self-Ensemble Protection (SEP), Hypocritical (HYPO), or TensorClog (TC).
Clause 12: A non-transitory computer-readable medium for training a machine-learning model to break obfuscated image data, the non-transitory computer-readable medium storing instructions that, when executed by at least one processor of a computing system, cause the computing system to perform operations, the operations including: receiving an original image dataset including image data that is obfuscated to machine learning, and performing an ensemble machine-learning training framework including at least one of: a stacking ensemble framework including: applying a first nonlinear transformation to the original image dataset to generate a transformed stacking image dataset, training a plurality of pre-trained machine-learning stacking models with the transformed stacking image dataset, obtaining probability predictions for the original image dataset with each of the plurality of pre-trained machine-learning stacking models, training a meta-learner model with the obtained probability predictions as an independent variable and with the original image dataset as a target variable, generating test predictions from the trained meta-learner model with the transformed image dataset, determining a respective prediction test accuracy for each of the test predictions, and for each of the plurality of pre-trained machine-learning models, in response to the prediction test accuracy being greater than a target test accuracy, outputting a corresponding final stacked model prediction image dataset, a boosting ensemble framework including: applying a first nonlinear transformation to the original image dataset to generate a transformed boosting image dataset, training a first pre-trained machine-learning boosting model with the transformed boosting image dataset, obtaining boosting prediction images for the original image dataset from the first pre-trained machine-learning boosting model with the transformed boosting image dataset, selecting misclassified images from among the boosting prediction images, applying a second nonlinear transformation to the misclassified images to generate a transformed misclassified image dataset, the second nonlinear transformation being a different type from the first nonlinear transformation, combining the transformed misclassified image dataset with the transformed boosting image dataset to generate a boosted image dataset, training a next pre-trained machine-learning boosting model with the boosted image dataset, obtaining additional boosting prediction images for the original image dataset from the pre-trained machine-learning boosting model with the boosted image dataset, repeating the selecting, applying, combining, re-training, and obtaining of the boosting ensemble framework k times, such that k pre-trained machine-learning boosting models are trained and k sets of boosting prediction images are obtained, where k is an integer greater than two, each subsequent iteration of misclassified images being assigned a greater weight than a preceding iteration of misclassified images, and outputting a final boosting prediction image dataset from among the k sets of boosting prediction images by majority voting based on respective test accuracies for each of the k pre-trained machine-learning boosting models, or a bagging ensemble framework including: splitting the original image dataset into a plurality of overlapped split image data subsets, applying at least one of a plurality of nonlinear transformations to each of the overlapped split image data subsets to generate corresponding transformed bagging image data subsets, training a respective pre-trained machine-learning bagging model with each of the transformed bagging image data subsets, obtaining bagging prediction images for the original image dataset from each of the pre-trained machine-learning bagging models with the transformed bagging image data subsets, and outputting a final bagging model prediction image dataset by combining the bagging prediction images by majority voting based on respective test accuracies for each of the pre-trained machine-learning bagging models.
Clause 13: The non-transitory computer-readable medium of clause 12, wherein the meta-learner model includes a logistic regression model.
Clause 14: The non-transitory computer-readable medium of clause 12, further including generating an evaluation of a final model prediction dataset, among any of output final stacked model prediction image dataset, final boosting prediction image dataset, or final bagging model prediction image dataset, the evaluation including a determination of accuracy of the final model prediction dataset.
Clause 15: The non-transitory computer-readable medium of clause 14, further including generating an evaluation of an accuracy of the performed ensemble machine-learning training framework.
Clause 16: The non-transitory computer-readable medium of clause 12, wherein each of the first nonlinear transformation, the second nonlinear transformation, and the a plurality of nonlinear transformations includes one or more of: erode, dilate, pixel manipulation, or grayscale.
Clause 17: The non-transitory computer-readable medium of clause 12, wherein an overlap percentage of the plurality of overlapped split image data subsets is 63% or 75%.
Clause 18: The non-transitory computer-readable medium of clause 12, wherein a number of epochs for training each pre-trained machine-learning stacking model, pre-trained machine-learning boosting model, and pre-trained machine-learning bagging model is 25-35.
Clause 19: The non-transitory computer-readable medium of clause 12, wherein each pre-trained machine-learning stacking model, pre-trained machine-learning boosting model, and pre-trained machine-learning bagging model is a deep neural network (DNN) model.
Clause 20: The non-transitory computer-readable medium of clause 12, wherein the original image dataset is obfuscated to machine learning by data protection including one or more of: Neural Tangent Generalization Attacks (NTGA), Error-Minimizing (EMin), Error-Maximizing (EMax), Deep-Confuse (DC), Synthetic (Syn), Auto Regressive (AR), Robust Error-Minimizing (REM), One-Pixel Shortcut (OPS), Entangled-Features (EntF), Self-Ensemble Protection (SEP), Hypocritical (HYPO), or TensorClog (TC).

Systems and software, e.g., implemented on a non-transitory computer-readable medium, for performing the methods discussed herein are also within the scope of embodiments of the present disclosure.

Embodiments of the present disclosure may thus utilize a special purpose or general-purpose computing system including computer hardware, such as, for example, one or more processors and system memory. Embodiments within the scope of the present disclosure also include physical and other computer-readable media for carrying or storing computer-executable instructions and/or data structures, including applications, tables, data, libraries, or other modules used to execute particular functions or direct selection or execution of other modules. Such computer-readable media can be any available media that can be accessed by a general purpose or special purpose computer system. Computer-readable media that store computer-executable instructions (or software instructions) are physical storage media. Computer-readable media that carry computer-executable instructions are transmission media. Thus, by way of example, and not limitation, embodiments of the present disclosure can include at least two distinctly different kinds of computer-readable media, namely physical storage media or transmission media. Combinations of physical storage media and transmission media should also be included within the scope of computer-readable media.

Both physical storage media and transmission media may be used temporarily store or carry software instructions in the form of computer readable program code that allows performance of embodiments of the present disclosure. Physical storage media may further be used to persistently or permanently store such software instructions. Examples of physical storage media include physical memory (e.g., RAM, ROM, EPROM, EEPROM, etc.), optical disk storage (e.g., CD, DVD, HDDVD, Blu-ray, etc.), storage devices (e.g., magnetic disk storage, tape storage, diskette, etc.), flash or other solid-state storage or memory, or any other non-transmission medium which can be used to store program code in the form of computer-executable instructions or data structures and which can be accessed by a general purpose or special purpose computer, whether such program code is stored as or in software, hardware, firmware, or combinations thereof.

A “network” or “communications network” may generally be defined as one or more data links that enable the transport of electronic data between computer systems and/or modules, engines, and/or other electronic devices. When information is transferred or provided over a communication network or another communications connection (either hardwired, wireless, or a combination of hardwired or wireless) to a computing device, the computing device properly views the connection as a transmission medium. Transmission media can include a communication network and/or data links, carrier waves, wireless signals, and the like, which can be used to carry desired program or template code means or instructions in the form of computer-executable instructions or data structures and which can be accessed by a general purpose or special purpose computer.

Further, upon reaching various computer system components, program code in the form of computer-executable instructions or data structures can be transferred automatically or manually from transmission media to physical storage media (or vice versa). For example, computer-executable instructions or data structures received over a network or data link can be buffered in memory (e.g., RAM) within a network interface module (NIC), and then eventually transferred to computer system RAM and/or to less volatile physical storage media at a computer system. Thus, it should be understood that physical storage media can be included in computer system components that also (or even primarily) utilize transmission media.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another.

Moreover, it should be appreciated that such a development effort might be complex and time consuming, but would nevertheless be a routine undertaking of design, fabrication, and manufacture for those of ordinary skill having the benefit of this disclosure.

As used in this specification and the claims, the singular forms “a,” “an,” and “the” include plural forms unless the context clearly dictates otherwise. The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims. Any trademarks mentioned herein are the property of their respective owners.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean up to plus or minus 10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion of additional components other than the components recited in the claims. The term “consisting essentially of” should be interpreted to be partially closed and allowing the inclusion only of additional components that do not fundamentally alter the nature of the claimed subject matter. Any trademarks are the property of their respective owners.

The phrase “such as” should be interpreted as “for example, including.” Moreover, the use of any and all example language, including but not limited to “such as”, is intended merely to better illuminate the invention and does not pose a limitation on the scope of the invention unless otherwise claimed.

Furthermore, in those instances where a convention analogous to “at least one of A, B and C, etc.” is used, in general such a construction is intended in the sense of one having ordinary skill in the art would understand the convention (e.g., “a system having at least one of A, B and C” would include but not be limited to systems that have A alone, B alone, C alone, A and B together, A and C together, B and C together, and/or A, B, and C together.). It will be further understood by those within the art that virtually any disjunctive word and/or phrase presenting two or more alternative terms, whether in the description or figures, should be understood to contemplate the possibilities of including one of the terms, either of the terms, or both terms. For example, the phrase “A or B” will be understood to include the possibilities of “A” or “B” or “A and B.”

All language such as “up to,” “at least,” “greater than,” “less than,” and the like, include the number recited and refer to ranges which can subsequently be broken down into ranges and subranges. A range includes each individual member. Thus, for example, a group having 1-3 members refers to groups having 1, 2, or 3 members. Similarly, a group having 6 members refers to groups having 1, 2, 3, 4, or 6 members, and so forth.

The modal verb “may” refers to the preferred use or selection of one or more options or choices among the several described embodiments or features contained within the same. Where no options or choices are disclosed regarding a particular embodiment or feature contained in the same, the modal verb “may” refers to an affirmative act regarding how to make or use an aspect of a described embodiment or feature contained in the same, or a definitive decision to use a specific skill regarding a described embodiment or feature contained in the same. In this latter context, the modal verb “may” has the same meaning and connotation as the auxiliary verb “can.”

In the foregoing specification, implementations of the disclosure have been described with reference to specific example implementations thereof. It will be evident that various modifications may be made thereto without departing from the broader spirit and scope of implementations of the disclosure as set forth in the following claims. The specification and drawings are, accordingly, to be regarded in an illustrative sense rather than a restrictive sense.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

1. A method for training a machine-learning model to break obfuscated image data, the method comprising:
receiving an original image dataset comprising image data that is obfuscated to machine learning; and
performing an ensemble machine-learning training framework comprising at least one of:
a stacking ensemble framework comprising:
applying a first nonlinear transformation to the original image dataset to generate a transformed stacking image dataset;
training a plurality of pre-trained machine-learning stacking models with the transformed stacking image dataset;
obtaining probability predictions for the original image dataset with each of the plurality of pre-trained machine-learning stacking models;
training a meta-learner model with the obtained probability predictions as an independent variable and with the original image dataset as a target variable;
generating test predictions from the trained meta-learner model with the transformed image dataset;
determining a respective prediction test accuracy for each of the test predictions; and
for each of the plurality of pre-trained machine-learning models, in response to the prediction test accuracy being greater than a target test accuracy, outputting a corresponding final stacked model prediction image dataset;
a boosting ensemble framework comprising:
applying a first nonlinear transformation to the original image dataset to generate a transformed boosting image dataset;
training a first pre-trained machine-learning boosting model with the transformed boosting image dataset;
obtaining boosting prediction images for the original image dataset from the first pre-trained machine-learning boosting model with the transformed boosting image dataset;
selecting misclassified images from among the boosting prediction images;
applying a second nonlinear transformation to the misclassified images to generate a transformed misclassified image dataset, the second nonlinear transformation being a different type from the first nonlinear transformation;
combining the transformed misclassified image dataset with the transformed boosting image dataset to generate a boosted image dataset;
training a next pre-trained machine-learning boosting model with the boosted image dataset;
obtaining additional boosting prediction images for the original image dataset from the pre-trained machine-learning boosting model with the boosted image dataset;
repeating the selecting, applying, combining, re-training, and obtaining of the boosting ensemble framework k times, such that k pre-trained machine-learning boosting models are trained and k sets of boosting prediction images are obtained, where k is an integer greater than two, each subsequent iteration of misclassified images being assigned a greater weight than a preceding iteration of misclassified images; and
outputting a final boosting prediction image dataset from among the k sets of boosting prediction images by majority voting based on respective test accuracies for each of the k pre-trained machine-learning boosting models; or
a bagging ensemble framework comprising:
splitting the original image dataset into a plurality of overlapped split image data subsets;
applying at least one of a plurality of nonlinear transformations to each of the overlapped split image data subsets to generate corresponding transformed bagging image data subsets;
training a respective pre-trained machine-learning bagging model with each of the transformed bagging image data subsets;
obtaining bagging prediction images for the original image dataset from each of the pre-trained machine-learning bagging models with the transformed bagging image data subsets; and
outputting a final bagging model prediction image dataset by combining the bagging prediction images by majority voting based on respective test accuracies for each of the pre-trained machine-learning bagging models.

2. The method of claim 1, wherein the meta-learner model comprises a logistic regression model.

3. The method of claim 1, further comprising generating an evaluation of a final model prediction dataset, among any of output final stacked model prediction image dataset, final boosting prediction image dataset, or final bagging model prediction image dataset, the evaluation including a determination of accuracy of the final model prediction dataset.

4. The method of claim 3, further comprising generating an evaluation of an accuracy of the performed ensemble machine-learning training framework.

5. The method of claim 1, wherein each of the first nonlinear transformation, the second nonlinear transformation, and the a plurality of nonlinear transformations comprises one or more of: erode, dilate, pixel manipulation, or grayscale.

6. The method of claim 5, wherein a separate pixel manipulation is applied for each of a plurality of color channels.

7. The method of claim 1, wherein an overlap percentage of the plurality of overlapped split image data subsets is 63% or 75%.

8. The method of claim 1, wherein a number of epochs for training each pre-trained machine-learning stacking model, pre-trained machine-learning boosting model, and pre-trained machine-learning bagging model is 25-35.

9. The method of claim 1, wherein each pre-trained machine-learning stacking model, pre-trained machine-learning boosting model, and pre-trained machine-learning bagging model is a deep neural network (DNN) model.

10. The method of claim 9, wherein the DNN model comprises one of: VGG19, VGG16, ExtendedVGG19, or ResNet50.

11. The method of claim 1, wherein the original image dataset is obfuscated to machine learning by data protection comprising one or more of: Neural Tangent Generalization Attacks (NTGA), Error-Minimizing (EMin), Error-Maximizing (EMax), Deep-Confuse (DC), Synthetic (Syn), Auto Regressive (AR), Robust Error-Minimizing (REM), One-Pixel Shortcut (OPS), Entangled-Features (EntF), Self-Ensemble Protection (SEP), Hypocritical (HYPO), or TensorClog (TC).

12. A non-transitory computer-readable medium for training a machine-learning model to break obfuscated image data, the non-transitory computer-readable medium storing instructions that, when executed by at least one processor of a computing system, cause the computing system to perform operations, the operations comprising:
receiving an original image dataset comprising image data that is obfuscated to machine learning; and
performing an ensemble machine-learning training framework comprising at least one of:
a stacking ensemble framework comprising:
applying a first nonlinear transformation to the original image dataset to generate a transformed stacking image dataset;
training a plurality of pre-trained machine-learning stacking models with the transformed stacking image dataset;
obtaining probability predictions for the original image dataset with each of the plurality of pre-trained machine-learning stacking models;
training a meta-learner model with the obtained probability predictions as an independent variable and with the original image dataset as a target variable;
generating test predictions from the trained meta-learner model with the transformed image dataset;
determining a respective prediction test accuracy for each of the test predictions; and
for each of the plurality of pre-trained machine-learning models, in response to the prediction test accuracy being greater than a target test accuracy, outputting a corresponding final stacked model prediction image dataset;
a boosting ensemble framework comprising:
applying a first nonlinear transformation to the original image dataset to generate a transformed boosting image dataset;
training a first pre-trained machine-learning boosting model with the transformed boosting image dataset;
obtaining boosting prediction images for the original image dataset from the first pre-trained machine-learning boosting model with the transformed boosting image dataset;
selecting misclassified images from among the boosting prediction images;
applying a second nonlinear transformation to the misclassified images to generate a transformed misclassified image dataset, the second nonlinear transformation being a different type from the first nonlinear transformation;
combining the transformed misclassified image dataset with the transformed boosting image dataset to generate a boosted image dataset;
training a next pre-trained machine-learning boosting model with the boosted image dataset;
obtaining additional boosting prediction images for the original image dataset from the pre-trained machine-learning boosting model with the boosted image dataset;
repeating the selecting, applying, combining, re-training, and obtaining of the boosting ensemble framework k times, such that k pre-trained machine-learning boosting models are trained and k sets of boosting prediction images are obtained, where k is an integer greater than two, each subsequent iteration of misclassified images being assigned a greater weight than a preceding iteration of misclassified images; and
outputting a final boosting prediction image dataset from among the k sets of boosting prediction images by majority voting based on respective test accuracies for each of the k pre-trained machine-learning boosting models; or
a bagging ensemble framework comprising:
splitting the original image dataset into a plurality of overlapped split image data subsets;
applying at least one of a plurality of nonlinear transformations to each of the overlapped split image data subsets to generate corresponding transformed bagging image data subsets;
training a respective pre-trained machine-learning bagging model with each of the transformed bagging image data subsets;
obtaining bagging prediction images for the original image dataset from each of the pre-trained machine-learning bagging models with the transformed bagging image data subsets; and
outputting a final bagging model prediction image dataset by combining the bagging prediction images by majority voting based on respective test accuracies for each of the pre-trained machine-learning bagging models.

13. The non-transitory computer-readable medium of claim 12, wherein the meta-learner model comprises a logistic regression model.

14. The non-transitory computer-readable medium of claim 12, further comprising generating an evaluation of a final model prediction dataset, among any of output final stacked model prediction image dataset, final boosting prediction image dataset, or final bagging model prediction image dataset, the evaluation including a determination of accuracy of the final model prediction dataset.

15. The non-transitory computer-readable medium of claim 14, further comprising generating an evaluation of an accuracy of the performed ensemble machine-learning training framework.

16. The non-transitory computer-readable medium of claim 12, wherein each of the first nonlinear transformation, the second nonlinear transformation, and the a plurality of nonlinear transformations comprises one or more of. erode, dilate, pixel manipulation, or grayscale.

17. The non-transitory computer-readable medium of claim 12, wherein an overlap percentage of the plurality of overlapped split image data subsets is 63% or 75%.

18. The non-transitory computer-readable medium of claim 12, wherein a number of epochs for training each pre-trained machine-learning stacking model, pre-trained machine-learning boosting model, and pre-trained machine-learning bagging model is 25-35.

19. The non-transitory computer-readable medium of claim 12, wherein each pre-trained machine-learning stacking model, pre-trained machine-learning boosting model, and pre-trained machine-learning bagging model is a deep neural network (DNN) model.

20. The non-transitory computer-readable medium of claim 12, wherein the original image dataset is obfuscated to machine learning by data protection comprising one or more of. Neural Tangent Generalization Attacks (NTGA), Error-Minimizing (EMin), Error-Maximizing (EMax), Deep-Confuse (DC), Synthetic (Syn), Auto Regressive (AR), Robust Error-Minimizing (REM), One-Pixel Shortcut (OPS), Entangled-Features (EntF), Self-Ensemble Protection (SEP), Hypocritical (HYPO), or TensorClog (TC).
